(19) United States
(12) Patent Application Publication
(10) Pub. No.: US 2025/0220322 A1
(43) Pub. Date: Jul. 3, 2025

(54) SENSOR DEVICE AND METHOD FOR OPERATING A SENSOR DEVICE

(71) Applicants: Sony Group Corporation, Tokyo (JP); ETH Zürich (Eidgenössische Technische Hochschule Zürich), Zürich (CH)

(72) Inventors: Valery VISHNEVSKIY, Zürich (CH); Diederik Paul MOEYS, Zürich (CH); Sebastian KOZERKE, Zürich (CH)

(73) Assignees: Sony Group Corporation, Tokyo (JP); ETH Zürich (Eidgenössische Technische Hochschule Zürich), Zürich (CH)

(21) Appl. No.: 18/850,604

(22) PCT Filed: Mar. 14, 2023
(86) PCT No.: PCT/EP2023/056489

§ 371 Date: Sep. 25, 2024

(30) Foreign Application Priority Data
Mar. 31, 2022 (EP) 22165748.9

(51) Int. Cl. H04N 25/77; H04N 23/71; H04N 23/72; H04N 23/73; H04N 23/76; H04N 25/47; H04N 25/60

(52) U.S. Cl. CPC H04N 25/77; H04N 23/71; H04N 23/72; H04N 23/76; H04N 25/47; H04N 23/73; H04N 25/60

(57) ABSTRACT

A sensor device comprises a plurality of pixels each configured to receive light and perform photoelectric conversion to generate an electrical signal, circuitry configured to generate image data from the electrical signals based on imaging parameters that are adjustable for each pixel, and a control unit. Here, the control unit is configured to divide for each of a series of specific time periods the plurality of pixels into at least a first subset of pixels and a second subset of pixels, to set for each specific time period to the pixels of each subset a different parameter value of at least one of the imaging parameters, and to generate final images by using the image data obtained via the at least two subsets of pixels during the respective specific time period.

### FIELD OF THE INVENTION

The present technology relates to a sensor device and a method for operating a sensor device, in particular, to a sensor device and a method for operating a sensor device that allows improved capturing of image streams.

### BACKGROUND

In imaging systems like active pixel sensors, APS, and dynamic/event vision sensors, DVS/EVS, readout parameters are tuned to achieve optimal image quality for a particular acquisition setup and scene. Such an approach forces a user to make a hard choice of sensor parameters before recording a scene, which leads in turn to a loss of information that could in principle be captured.

This issue is even more pronounced when the scene is diverse in contrast and actions, as is e.g. the case for high dynamic range, slow and fast moving objects, and the like. In addition, single, fixed sensor parameters would inevitably compromise the overall quality of the acquired data in a single sensor setup.

One example for such complementary reconstruction properties for image generation is the tradeoff between signal-to-noise ratio, SNR, and resolution, which is fundamental to virtually any imaging system. Here, tuning parameters of an acquisition system allows achieving a desirable tradeoff for a particular scene setup such as low light, fast moving objects, and the like. However, problems will arise, if a scene requires presence of two complementary parameter settings.

For example, an EVS registers intensity changes, when the contrast variation at a pixel exceeded an event detection threshold value, which defines the sensitivity of the sensor. When the threshold is too large, it will take more time for intensity changes to exceed it. Then, fewer events are registered and, consequently, the temporal resolution decreases. Contrary, due to the physics of the sensor, lower threshold values yield more noise in the EVS signal, however at higher temporal resolution. Thus, it is typically not possible to capture EVS data with low noise, i.e. high SNR, and at the same with high temporal resolution.

The same problem arises for other parameters. For example, a low bandwidth of EVS pixels will improve the SNR, but worsen the temporal resolution. Further, the time of inactivity of an EVS pixel after pixel detection (so-called refractory period) will naturally affect the temporal resolution.

Just the same, in APS imaging parameters like the exposure time, the source follower bias current that sets the offset of the pixel signal, or the gain setting trade sensitivity vs. noise.

An improved image reconstruction is therefore desirable that mitigates the above problems.

### SUMMARY OF INVENTION

To this end, a sensor device is provided that comprises a plurality of pixels each configured to receive light and perform photoelectric conversion to generate an electrical signal, circuitry configured to generate image data from the electrical signals based on imaging parameters that are adjustable for each pixel, and a control unit. Here, the control unit is configured to divide for each of a series of specific time periods the plurality of pixels into at least a first subset of pixels and a second subset of pixels, to set for each specific time period to the pixels of each subset a different parameter value of at least one of the imaging parameters, and to generate final images by using the image data obtained via the at least two subsets of pixels during the respective specific time period.

Further, a method for operating the sensor device comprises: receiving light and performing photoelectric conversion with a plurality of pixels of the sensor device to generate an electrical signal; generating with circuitry of the sensor device image data from the electrical signals based on imaging parameters that are adjustable for each pixel; dividing for each of a series of specific time periods the plurality of pixels into at least a first subset of pixels and a second subset of pixels; setting for each specific time period to the pixels of each subset a different parameter value of at least one of the imaging parameters; and generating final images by using the image data obtained via the at least two subsets of pixels during the respective specific time period.

By using different parameter values for image reconstruction for different pixels, it is possible to generate with a single set of a plurality of pixels different image data on a scene that can be optimized for different capturing conditions. These image data can then be combined to generate a final image that looks as if captured with all capturing conditions optimized. By newly dividing the pixels into different subsets within each of a series of specific time periods the optimized capturing conditions for the single pixels vary with time. This ensures that a reconstruction of a video stream based on the full image data is possible, although each subset of pixels only includes a part of the pixels. In this manner, the quality of images captured by a single sensor can be improved, since a larger part of information that could in principle be captured is made available.

### BRIEF DESCRIPTION OF DRAWINGS

FIG. 1 is a schematic diagram of a sensor device.

FIG. 2 is a schematic block diagram of a sensor section.

FIG. 3 is a schematic block diagram of a pixel array section.

FIG. 4 is a schematic circuit diagram of a pixel block.

FIG. 5 is a schematic block diagram illustrating of an event detecting section.

FIG. 6 is a schematic circuit diagram of a current-voltage converting section.

FIG. 7 is a schematic circuit diagram of a subtraction section and a quantization section.

FIG. 8 is a schematic timing chart of an example operation of the sensor section.

FIG. 9 is a schematic diagram of a frame data generation method based on event data.

FIG. 10 is a schematic block diagram of another quantization section.

FIG. 11 is a schematic diagram of another event detecting section.

FIG. 12 is a schematic block diagram of another pixel array section.

FIG. 13 is a schematic circuit diagram of another pixel block.

FIG. 14 is a schematic block diagram of a scan-type sensor device.

FIG. 15 is a schematic block diagram of a sensor device.

FIG. 16 is a schematic illustration of the assignment of imaging parameter values in a sensor device.

FIG. 17 is a schematic illustration of a prediction of imaging parameter value assignment.

FIG. 18 is a further schematic illustration of a prediction of imaging parameter value assignment.

FIG. 19 is a schematic illustration of different reconstruction modes for generating final images.

FIG. 20 is a schematic block diagram of a sensor device on a chip.

FIG. 21 illustrates schematically a process flow of a method for operating a sensor device

FIG. 22 is a schematic block diagram of a vehicle control system.

FIG. 23 is a diagram of assistance in explaining an example of installation positions of an outside-vehicle information detecting section and an imaging section.

### DETAILED DESCRIPTION

The present disclosure is directed to mitigating problems occurring for pixel based sensor devices in which imaging needs to be optimized for different imaging conditions by setting according parameter values of imaging parameters.

The solutions to this problem discussed below are applicable to all according sensor types. However, in order to ease the description and also in order to cover an important application example, the present description is focused without prejudice on DVS/EVS. It has to be understood that although in the following often reference will be made to the circuitry of DVS/EVS, the discussed solutions can be applied in principle to all pixel based sensor devices. The discussed sensor devices may be implemented in any imaging sensor setup such as e.g. smartphone cameras, scientific devices, automotive video sensors or the like.

First, a possible implementation of a DVS/EVS will be described. This is of course purely exemplary. It is to be understood that DVSs/EVSs could also be implemented differently.

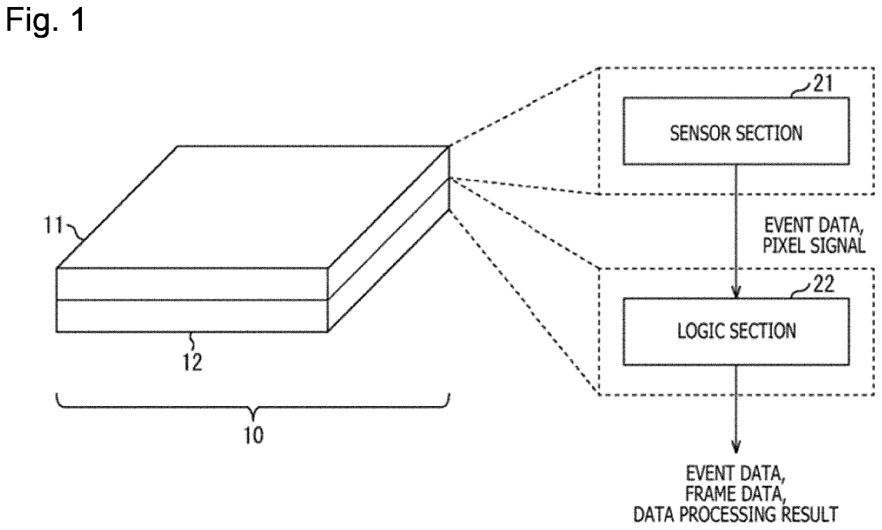

FIG. 1 is a diagram illustrating a configuration example of a sensor device 10, which is in the example of FIG. 1 constituted by a sensor chip.

The sensor device 10 is a single-chip semiconductor chip and includes a sensor die (substrate) 11, which serves as a plurality of dies (substrates), and a logic die 12 that are stacked. Note that, the sensor device 10 can also include only a single die or three or more stacked dies.

In the sensor device 10 of FIG. 1, the sensor die 11 includes (a circuit serving as) a sensor section 21, and the logic die 12 includes a logic section 22. Note that, the sensor section 21 can be partly formed on the logic die 12. Further, the logic section 22 can be partly formed on the sensor die 11.

The sensor section 21 includes pixels configured to perform photoelectric conversion on incident light to generate electrical signals, and generates event data indicating the occurrence of events that are changes in the electrical signal of the pixels. The sensor section 21 supplies the event data to the logic section 22. That is, the sensor section 21 performs imaging of performing, in the pixels, photoelectric conversion on incident light to generate electrical signals, similarly to a synchronous image sensor, for example. The sensor section 21, however, generates event data indicating the occurrence of events that are changes in the electrical signal of the pixels instead of generating image data in a frame format (frame data). The sensor section 21 outputs, to the logic section 22, the event data obtained by the imaging.

Here, the synchronous image sensor is an image sensor configured to perform imaging in synchronization with a vertical synchronization signal and output frame data that is image data in a frame format. The sensor section 21 can be regarded as asynchronous (an asynchronous image sensor) in contrast to the synchronous image sensor, since the sensor section 21 does not operate in synchronization with a vertical synchronization signal when outputting event data.

Note that, the sensor section 21 can generate and output, other than event data, frame data, similarly to the synchronous image sensor. In addition, the sensor section 21 can output, together with event data, electrical signals of pixels in which events have occurred, as pixel signals that are pixel values of the pixels in frame data.

The logic section 22 controls the sensor section 21 as needed. Further, the logic section 22 performs various types of data processing, such as data processing of generating frame data on the basis of event data from the sensor section 21 and image processing on frame data from the sensor section 21 or frame data generated on the basis of the event data from the sensor section 21, and outputs data processing results obtained by performing the various types of data processing on the event data and the frame data.

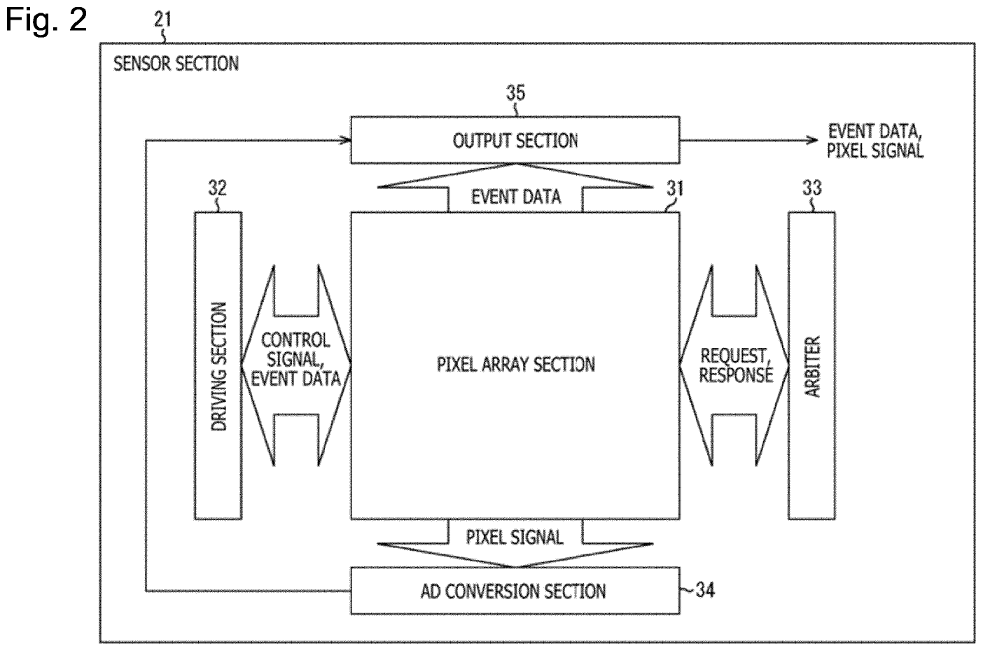

FIG. 2 is a block diagram illustrating a configuration example of the sensor section 21 of FIG. 1.

The sensor section 21 includes a pixel array section 31, a driving section 32, an arbiter 33, an AD (Analog to Digital) conversion section 34, and an output section 35.

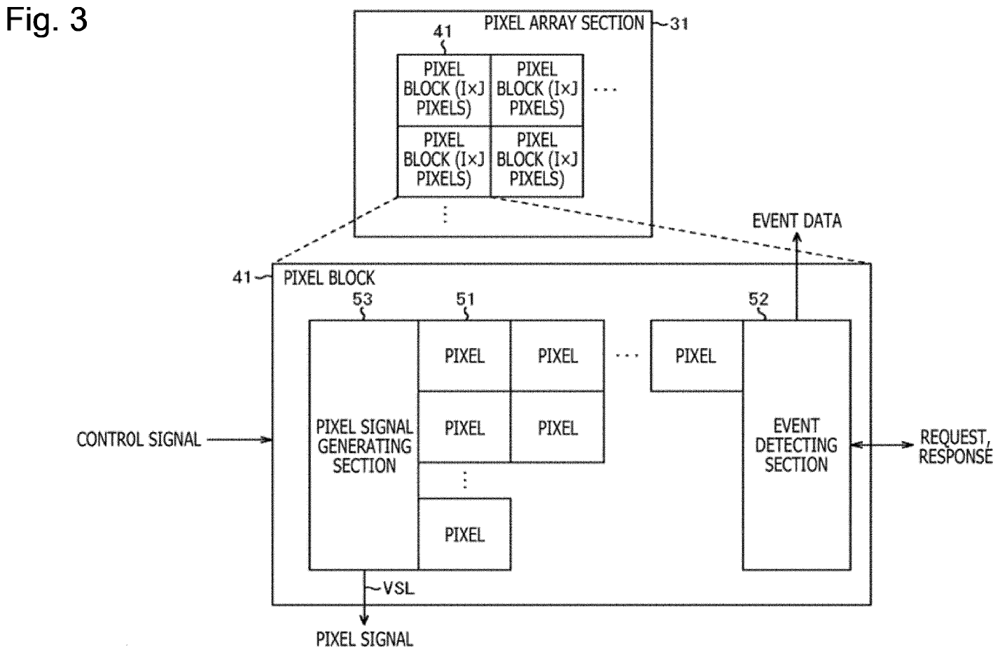

The pixel array section 31 includes a plurality of pixels 51 (FIG. 3) arrayed in a two-dimensional lattice pattern. The pixel array section 31 detects, in a case where a change larger than a predetermined threshold (including a change equal to or larger than the threshold as needed) has occurred in (a voltage corresponding to) a photocurrent that is an electrical signal generated by photoelectric conversion in the pixel 51, the change in the photocurrent as an event. In a case of detecting an event, the pixel array section 31 outputs, to the arbiter 33, a request for requesting the output of event data indicating the occurrence of the event. Then, in a case of receiving a response indicating event data output permission from the arbiter 33, the pixel array section 31 outputs the event data to the driving section 32 and the output section 35. In addition, the pixel array section 31 outputs an electrical signal of the pixel 51 in which the event has been detected to the AD conversion section 34, as a pixel signal.

The driving section 32 supplies control signals to the pixel array section 31 to drive the pixel array section 31. For example, the driving section 32 drives the pixel 51 regarding which the pixel array section 31 has output event data, so that the pixel 51 in question supplies (outputs) a pixel signal to the AD conversion section 34.

The arbiter 33 arbitrates the requests for requesting the output of event data from the pixel array section 31, and returns responses indicating event data output permission or prohibition to the pixel array section 31.

The AD conversion section 34 includes, for example, a single-slope ADC (AD converter) (not illustrated) in each column of pixel blocks 41 (FIG. 3) described later, for example. The AD conversion section 34 performs, with the ADC in each column, AD conversion on pixel signals of the pixels 51 of the pixel blocks 41 in the column, and supplies the resultant to the output section 35. Note that, the AD conversion section 34 can perform CDS (Correlated Double Sampling) together with pixel signal AD conversion.

The output section 35 performs necessary processing on the pixel signals from the AD conversion section 34 and the event data from the pixel array section 31 and supplies the resultant to the logic section 22 (FIG. 1).

Here, a change in the photocurrent generated in the pixel 51 can be recognized as a change in the amount of light entering the pixel 51, so that it can also be said that an event is a change in light amount (a change in light amount larger than the threshold) in the pixel 51.

Event data indicating the occurrence of an event at least includes location information (coordinates or the like) indicating the location of a pixel block in which a change in light amount, which is the event, has occurred. Besides, the event data can also include the polarity (positive or negative) of the change in light amount.

With regard to the series of event data that is output from the pixel array section 31 at timings at which events have occurred, it can be said that, as long as the event data interval is the same as the event occurrence interval, the event data implicitly includes time point information indicating (relative) time points at which the events have occurred. However, for example, when the event data is stored in a memory and the event data interval is no longer the same as the event occurrence interval, the time point information implicitly included in the event data is lost. Thus, the output section 35 includes, in event data, time point information indicating (relative) time points at which events have occurred, such as timestamps, before the event data interval is changed from the event occurrence interval. The processing of including time point information in event data can be performed in any block other than the output section 35 as long as the processing is performed before time point information implicitly included in event data is lost.

FIG. 3 is a block diagram illustrating a configuration example of the pixel array section 31 of FIG. 2.

The pixel array section 31 includes the plurality of pixel blocks 41. The pixel block 41 includes the I×J pixels 51 that are one or more pixels arrayed in I rows and J columns (I and J are integers), an event detecting section 52, and a pixel signal generating section 53. The one or more pixels 51 in the pixel block 41 share the event detecting section 52 and the pixel signal generating section 53. Further, in each column of the pixel blocks 41, a VSL (Vertical Signal Line) for connecting the pixel blocks 41 to the ADC of the AD conversion section 34 is wired.

The pixel 51 receives light incident from an object and performs photoelectric conversion to generate a photocurrent serving as an electrical signal. The pixel 51 supplies the photocurrent to the event detecting section 52 under the control of the driving section 32.

The event detecting section 52 detects, as an event, a change larger than the predetermined threshold in photocurrent from each of the pixels 51, under the control of the driving section 32. In a case of detecting an event, the event detecting section 52 supplies, to the arbiter 33 (FIG. 2), a request for requesting the output of event data indicating the occurrence of the event. Then, when receiving a response indicating event data output permission to the request from the arbiter 33, the event detecting section 52 outputs the event data to the driving section 32 and the output section 35.

The pixel signal generating section 53 generates, in the case where the event detecting section 52 has detected an event, a voltage corresponding to a photocurrent from the pixel 51 as a pixel signal, and supplies the voltage to the AD conversion section 34 through the VSL, under the control of the driving section 32.

Here, detecting a change larger than the predetermined threshold in photocurrent as an event can also be recognized as detecting, as an event, absence of change larger than the predetermined threshold in photocurrent. The pixel signal generating section 53 can generate a pixel signal in the case where absence of change larger than the predetermined threshold in photocurrent has been detected as an event as well as in the case where a change larger than the predetermined threshold in photocurrent has been detected as an event.

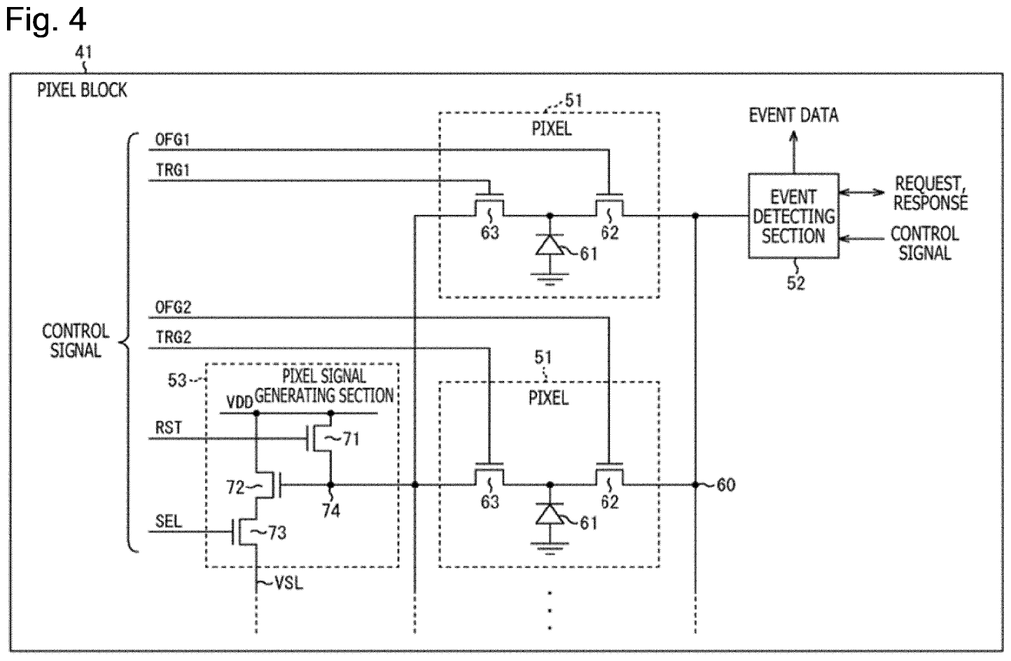

FIG. 4 is a circuit diagram illustrating a configuration example of the pixel block 41.

The pixel block 41 includes, as described with reference to FIG. 3, the pixels 51, the event detecting section 52, and the pixel signal generating section 53.

The pixel 51 includes a photoelectric conversion element 61 and transfer transistors 62 and 63.

The photoelectric conversion element 61 includes, for example, a PD (Photodiode). The photoelectric conversion element 61 receives incident light and performs photoelectric conversion to generate charges.

The transfer transistor 62 includes, for example, an N (Negative)-type MOS (Metal-Oxide-Semiconductor) FET (Field Effect Transistor). The transfer transistor 62 of the n-th pixel 51 of the I×J pixels 51 in the pixel block 41 is turned on or off in response to a control signal OFGn supplied from the driving section 32 (FIG. 2). When the transfer transistor 62 is turned on, charges generated in the photoelectric conversion element 61 are transferred (supplied) to the event detecting section 52, as a photocurrent.

The transfer transistor 63 includes, for example, an N-type MOSFET. The transfer transistor 63 of the n-th pixel 51 of the I×J pixels 51 in the pixel block 41 is turned on or off in response to a control signal TRGn supplied from the driving section 32. When the transfer transistor 63 is turned on, charges generated in the photoelectric conversion element 61 are transferred to an FD 74 of the pixel signal generating section 53.

The I×J pixels 51 in the pixel block 41 are connected to the event detecting section 52 of the pixel block 41 through nodes 60. Thus, photocurrents generated in (the photoelectric conversion elements 61 of) the pixels 51 are supplied to the event detecting section 52 through the nodes 60. As a result, the event detecting section 52 receives the sum of photocurrents from all the pixels 51 in the pixel block 41. Thus, the event detecting section 52 detects, as an event, a change in sum of photocurrents supplied from the I×J pixels 51 in the pixel block 41.

The pixel signal generating section 53 includes a reset transistor 71, an amplification transistor 72, a selection transistor 73, and the FD (Floating Diffusion) 74.

The reset transistor 71, the amplification transistor 72, and the selection transistor 73 include, for example, N-type MOSFETs.

The reset transistor 71 is turned on or off in response to a control signal RST supplied from the driving section 32 (FIG. 2). When the reset transistor 71 is turned on, the FD 74 is connected to a power supply VDD, and charges accumulated in the FD 74 are thus discharged to the power supply VDD. With this, the FD 74 is reset.

The amplification transistor 72 has a gate connected to the FD 74, a drain connected to the power supply VDD, and a source connected to the VSL through the selection transistor 73. The amplification transistor 72 is a source follower and outputs a voltage (electrical signal) corresponding to the voltage of the FD 74 supplied to the gate to the VSL through the selection transistor 73.

The selection transistor 73 is turned on or off in response to a control signal SEL supplied from the driving section 32. When the selection transistor 73 is turned on, a voltage corresponding to the voltage of the FD 74 from the amplification transistor 72 is output to the VSL.

The FD 74 accumulates charges transferred from the photoelectric conversion elements 61 of the pixels 51 through the transfer transistors 63, and converts the charges to voltages.

With regard to the pixels 51 and the pixel signal generating section 53, which are configured as described above, the driving section 32 turns on the transfer transistors 62 with control signals OFGn, so that the transfer transistors 62 supply, to the event detecting section 52, photocurrents based on charges generated in the photoelectric conversion elements 61 of the pixels 51. With this, the event detecting section 52 receives a current that is the sum of the photocurrents from all the pixels 51 in the pixel block 41, which might also be only a single pixel.

When the event detecting section 52 detects, as an event, a change in photocurrent (sum of photocurrents) in the pixel block 41, the driving section 32 turns off the transfer transistors 62 of all the pixels 51 in the pixel block 41, to thereby stop the supply of the photocurrents to the event detecting section 52. Then, the driving section 32 sequentially turns on, with the control signals TRGn, the transfer transistors 63 of the pixels 51 in the pixel block 41 in which the event has been detected, so that the transfer transistors 63 transfers charges generated in the photoelectric conversion elements 61 to the FD 74. The FD 74 accumulates the charges transferred from (the photoelectric conversion elements 61 of) the pixels 51. Voltages corresponding to the charges accumulated in the FD 74 are output to the VSL, as pixel signals of the pixels 51, through the amplification transistor 72 and the selection transistor 73.

As described above, in the sensor section 21 (FIG. 2), only pixel signals of the pixels 51 in the pixel block 41 in which an event has been detected are sequentially output to the VSL. The pixel signals output to the VSL are supplied to the AD conversion section 34 to be subjected to AD conversion.

Here, in the pixels 51 in the pixel block 41, the transfer transistors 63 can be turned on not sequentially but simultaneously. In this case, the sum of pixel signals of all the pixels 51 in the pixel block 41 can be output.

In the pixel array section 31 of FIG. 3, the pixel block 41 includes one or more pixels 51, and the one or more pixels 51 share the event detecting section 52 and the pixel signal generating section 53. Thus, in the case where the pixel block 41 includes a plurality of pixels 51, the numbers of the event detecting sections 52 and the pixel signal generating sections 53 can be reduced as compared to a case where the event detecting section 52 and the pixel signal generating section 53 are provided for each of the pixels 51, with the result that the scale of the pixel array section 31 can be reduced.

Note that, in the case where the pixel block 41 includes a plurality of pixels 51, the event detecting section 52 can be provided for each of the pixels 51. In the case where the plurality of pixels 51 in the pixel block 41 share the event detecting section 52, events are detected in units of the pixel blocks 41. In the case where the event detecting section 52 is provided for each of the pixels 51, however, events can be detected in units of the pixels 51.

Yet, even in the case where the plurality of pixels 51 in the pixel block 41 share the single event detecting section 52, events can be detected in units of the pixels 51 when the transfer transistors 62 of the plurality of pixels 51 are temporarily turned on in a time-division manner.

Further, in a case where there is no need to output pixel signals, the pixel block 41 can be formed without the pixel signal generating section 53. In the case where the pixel block 41 is formed without the pixel signal generating section 53, the sensor section 21 can be formed without the AD conversion section 34 and the transfer transistors 63. In this case, the scale of the sensor section 21 can be reduced. The sensor will then output the address of the pixel (block) in which the event occurred, if necessary with a time stamp.

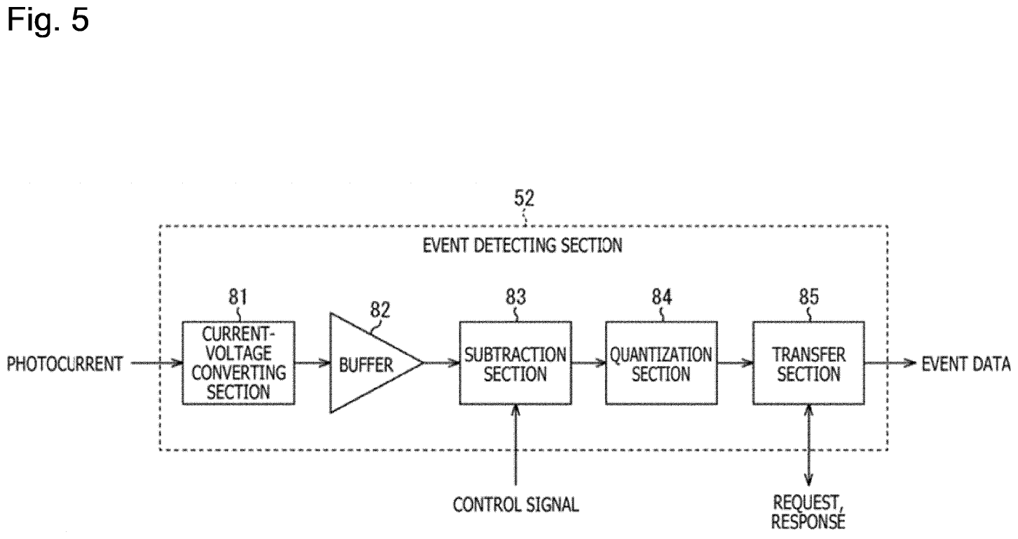

FIG. 5 is a block diagram illustrating a configuration example of the event detecting section 52 of FIG. 3.

The event detecting section 52 includes a current-voltage converting section 81, a buffer 82, a subtraction section 83, a quantization section 84, and a transfer section 85.

The current-voltage converting section 81 converts (a sum of) photocurrents from the pixels 51 to voltages corresponding to the logarithms of the photocurrents (hereinafter also referred to as a “photovoltage”) and supplies the voltages to the buffer 82.

The buffer 82 buffers photovoltages from the current-voltage converting section 81 and supplies the resultant to the subtraction section 83.

The subtraction section 83 calculates, at a timing instructed by a row driving signal that is a control signal from the driving section 32, a difference between the current photovoltage and a photovoltage at a timing slightly shifted from the current time, and supplies a difference signal corresponding to the difference to the quantization section 84.

The quantization section 84 quantizes difference signals from the subtraction section 83 to digital signals and supplies the quantized values of the difference signals to the transfer section 85 as event data.

The transfer section 85 transfers (outputs), on the basis of event data from the quantization section 84, the event data to the output section 35. That is, the transfer section 85 supplies a request for requesting the output of the event data to the arbiter 33. Then, when receiving a response indicating event data output permission to the request from the arbiter 33, the transfer section 85 outputs the event data to the output section 35.

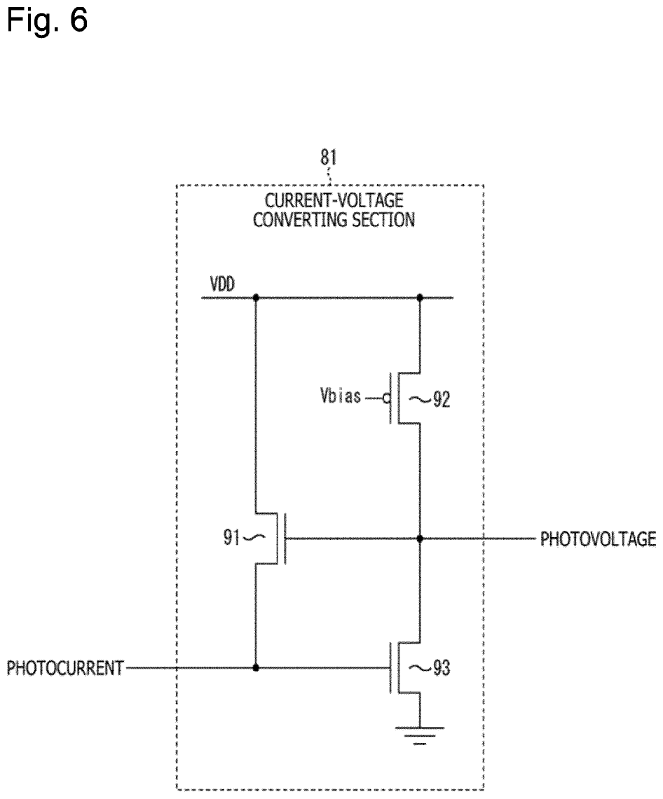

FIG. 6 is a circuit diagram illustrating a configuration example of the current-voltage converting section 81 of FIG. 5.

The current-voltage converting section 81 includes transistors 91 to 93. As the transistors 91 and 93, for example, N-type MOSFETs can be employed. As the transistor 92, for example, a P-type MOSFET can be employed.

The transistor 91 has a source connected to the gate of the transistor 93, and a photocurrent is supplied from the pixel 51 to the connecting point between the source of the transistor 91 and the gate of the transistor 93. The transistor 91 has a drain connected to the power supply VDD and a gate connected to the drain of the transistor 93.

The transistor 92 has a source connected to the power supply VDD and a drain connected to the connecting point between the gate of the transistor 91 and the drain of the transistor 93. A predetermined bias voltage Vbias is applied to the gate of the transistor 92. With the bias voltage Vbias, the transistor 92 is turned on or off, and the operation of the current-voltage converting section 81 is turned on or off depending on whether the transistor 92 is turned on or off.

The source of the transistor 93 is grounded.

In the current-voltage converting section 81, the transistor 91 has the drain connected on the power supply VDD side. The source of the transistor 91 is connected to the pixels 51 (FIG. 4), so that photocurrents based on charges generated in the photoelectric conversion elements 61 of the pixels 51 flow through the transistor 91 (from the drain to the source). The transistor 91 operates in a subthreshold region, and at the gate of the transistor 91, photovoltages corresponding to the logarithms of the photocurrents flowing through the transistor 91 are generated. As described above, in the current-voltage converting section 81, the transistor 91 converts photocurrents from the pixels 51 to photovoltages corresponding to the logarithms of the photocurrents.

In the current-voltage converting section 81, the transistor 91 has the gate connected to the connecting point between the drain of the transistor 92 and the drain of the transistor 93, and the photovoltages are output from the connecting point in question.

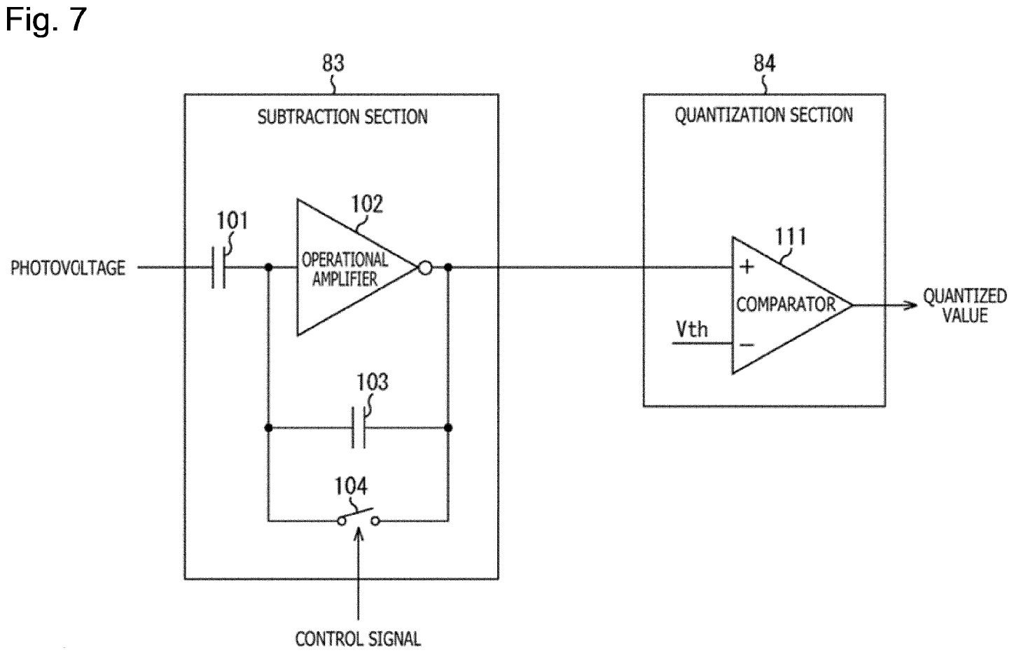

FIG. 7 is a circuit diagram illustrating configuration examples of the subtraction section 83 and the quantization section 84 of FIG. 5.

The subtraction section 83 includes a capacitor 101, an operational amplifier 102, a capacitor 103, and a switch 104. The quantization section 84 includes a comparator 111.

The capacitor 101 has one end connected to the output terminal of the buffer 82 (FIG. 5) and the other end connected to the input terminal (inverting input terminal) of the operational amplifier 102. Thus, photovoltages are input to the input terminal of the operational amplifier 102 through the capacitor 101.

The operational amplifier 102 has an output terminal connected to the non-inverting input terminal (+) of the comparator 111.

The capacitor 103 has one end connected to the input terminal of the operational amplifier 102 and the other end connected to the output terminal of the operational amplifier 102.

The switch 104 is connected to the capacitor 103 to switch the connections between the ends of the capacitor 103. The switch 104 is turned on or off in response to a row driving signal that is a control signal from the driving section 32, to thereby switch the connections between the ends of the capacitor 103.

A photovoltage on the buffer 82 (FIG. 5) side of the capacitor 101 when the switch 104 is on is denoted by Vinit, and the capacitance (electrostatic capacitance) of the capacitor 101 is denoted by C1. The input terminal of the operational amplifier 102 serves as a virtual ground terminal, and a charge Qinit that is accumulated in the capacitor 101 in the case where the switch 104 is on is expressed by Expression (1).

$$Qinit = C 1 \times Vinit \qquad ( 1 )$$

Further, in the case where the switch 104 is on, the connection between the ends of the capacitor 103 is cut (short-circuited), so that no charge is accumulated in the capacitor 103.

When a photovoltage on the buffer 82 (FIG. 5) side of the capacitor 101 in the case where the switch 104 has thereafter been turned off is denoted by Vafter, a charge Qafter that is accumulated in the capacitor 101 in the case where the switch 104 is off is expressed by Expression (2).

$$Qafter = C 1 \times Vafter \qquad ( 2 )$$

When the capacitance of the capacitor 103 is denoted by C2 and the output voltage of the operational amplifier 102 is denoted by Vout, a charge Q2 that is accumulated in the capacitor 103 is expressed by Expression (3).

$$Q 2 = - C 2 \times Vout \qquad ( 3 )$$

Since the total amount of charges in the capacitors 101 and 103 does not change before and after the switch 104 is turned off, Expression (4) is established.

$$Qinit = Qafter + Q 2 \qquad ( 4 )$$

When Expression (1) to Expression (3) are substituted for Expression (4), Expression (5) is obtained.

$$Vout = - ( C 1 / C 2 ) \times ( Vafter - Vinit ) \qquad ( 5 )$$

With Expression (5), the subtraction section 83 subtracts the photovoltage Vinit from the photovoltage Vafter, that is, calculates the difference signal (Vout) corresponding to a difference Vafter-Vinit between the photovoltages Vafter and Vinit. With Expression (5), the subtraction gain of the subtraction section 83 is C1/C2. Since the maximum gain is normally desired, C1 is preferably set to a large value and C2 is preferably set to a small value. Meanwhile, when C2 is too small, kTC noise increases, resulting in a risk of deteriorated noise characteristics. Thus, the capacitance C2 can only be reduced in a range that achieves acceptable noise. Further, since the pixel blocks 41 each have installed therein the event detecting section 52 including the subtraction section 83, the capacitances C1 and C2 have space constraints. In consideration of these matters, the values of the capacitances C1 and C2 are determined.

The comparator 111 compares a difference signal from the subtraction section 83 with a predetermined threshold (voltage) Vth (>0) applied to the inverting input terminal (−), thereby quantizing the difference signal. The comparator 111 outputs the quantized value obtained by the quantization to the transfer section 85 as event data.

For example, in a case where a difference signal is larger than the threshold Vth, the comparator 111 outputs an H (High) level indicating 1, as event data indicating the occurrence of an event. In a case where a difference signal is not larger than the threshold Vth, the comparator 111 outputs an L (Low) level indicating 0, as event data indicating that no event has occurred.

The transfer section 85 supplies a request to the arbiter 33 in a case where it is confirmed on the basis of event data from the quantization section 84 that a change in light amount that is an event has occurred, that is, in the case where the difference signal (Vout) is larger than the threshold Vth. When receiving a response indicating event data output permission, the transfer section 85 outputs the event data indicating the occurrence of the event (for example, H level) to the output section 35.

The output section 35 includes, in event data from the transfer section 85, location/address information regarding (the pixel block 41 including) the pixel 51 in which an event indicated by the event data has occurred and time point information indicating a time point at which the event has occurred, and further, as needed, the polarity of a change in light amount that is the event, i.e. whether the intensity did increase or decrease. The output section 35 outputs the event data.

As the data format of event data including location information regarding the pixel 51 in which an event has occurred, time point information indicating a time point at which the event has occurred, and the polarity of a change in light amount that is the event, for example, the data format called “AER (Address Event Representation)” can be employed.

Note that, a gain A of the entire event detecting section 52 is expressed by the following expression where the gain of the current-voltage converting section 81 is denoted by CG_{log} and the gain of the buffer 82 is 1.

$$A = {CG}_{log} C 1 / C 2 ( \sum {i}_{photo} \_n ) \qquad ( 6 )$$

Here, i_{photo_n} denotes a photocurrent of the n-th pixel 51 of the I×J pixels 51 in the pixel block 41. In Expression (6), Σ denotes the summation of n that takes integers ranging from 1 to I×J.

Note that, the pixel 51 can receive any light as incident light with an optical filter through which predetermined light passes, such as a color filter. For example, in a case where the pixel 51 receives visible light as incident light, event data indicates the occurrence of changes in pixel value in images including visible objects. Further, for example, in a case where the pixel 51 receives, as incident light, infrared light, millimeter waves, or the like for ranging, event data indicates the occurrence of changes in distances to objects. In addition, for example, in a case where the pixel 51 receives infrared light for temperature measurement, as incident light, event data indicates the occurrence of changes in temperature of objects. In the present embodiment, the pixel 51 is assumed to receive visible light as incident light.

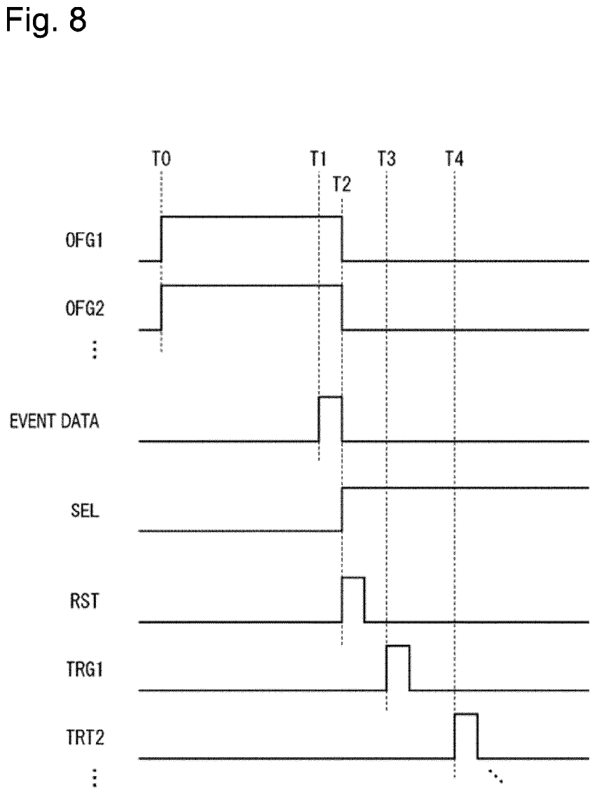

FIG. 8 is a timing chart illustrating an example of the operation of the sensor section 21 of FIG. 2.

At Timing T0, the driving section 32 changes all the control signals OFGn from the L level to the H level, thereby turning on the transfer transistors 62 of all the pixels 51 in the pixel block 41. With this, the sum of photocurrents from all the pixels 51 in the pixel block 41 is supplied to the event detecting section 52. Here, the control signals TRGn are all at the L level, and hence the transfer transistors 63 of all the pixels 51 are off.

For example, at Timing T1, when detecting an event, the event detecting section 52 outputs event data at the H level in response to the detection of the event.

At Timing T2, the driving section 32 sets all the control signals OFGn to the L level on the basis of the event data at the H level, to stop the supply of the photocurrents from the pixels 51 to the event detecting section 52. Further, the driving section 32 sets the control signal SEL to the H level, and sets the control signal RST to the H level over a certain period of time, to control the FD 74 to discharge the charges to the power supply VDD, thereby resetting the FD 74. The pixel signal generating section 53 outputs, as a reset level, a pixel signal corresponding to the voltage of the FD 74 when the FD 74 has been reset, and the AD conversion section 34 performs AD conversion on the reset level.

At Timing T3 after the reset level AD conversion, the driving section 32 sets a control signal TRG1 to the H level over a certain period to control the first pixel 51 in the pixel block 41 in which the event has been detected to transfer, to the FD 74, charges generated by photoelectric conversion in (the photoelectric conversion element 61 of) the first pixel 51. The pixel signal generating section 53 outputs, as a signal level, a pixel signal corresponding to the voltage of the FD 74 to which the charges have been transferred from the pixel 51, and the AD conversion section 34 performs AD conversion on the signal level.

The AD conversion section 34 outputs, to the output section 35, a difference between the signal level and the reset level obtained after the AD conversion, as a pixel signal serving as a pixel value of the image (frame data).

Here, the processing of obtaining a difference between a signal level and a reset level as a pixel signal serving as a pixel value of an image is called “CDS.” CDS can be performed after the AD conversion of a signal level and a reset level, or can be simultaneously performed with the AD conversion of a signal level and a reset level in a case where the AD conversion section 34 performs single-slope AD conversion. In the latter case, AD conversion is performed on the signal level by using the AD conversion result of the reset level as an initial value.

At Timing T4 after the AD conversion of the pixel signal of the first pixel 51 in the pixel block 41, the driving section 32 sets a control signal TRG2 to the H level over a certain period of time to control the second pixel 51 in the pixel block 41 in which the event has been detected to output a pixel signal.

In the sensor section 21, similar processing is executed thereafter, so that pixel signals of the pixels 51 in the pixel block 41 in which the event has been detected are sequentially output.

When the pixel signals of all the pixels 51 in the pixel block 41 are output, the driving section 32 sets all the control signals OFGn to the H level to turn on the transfer transistors 62 of all the pixels 51 in the pixel block 41.

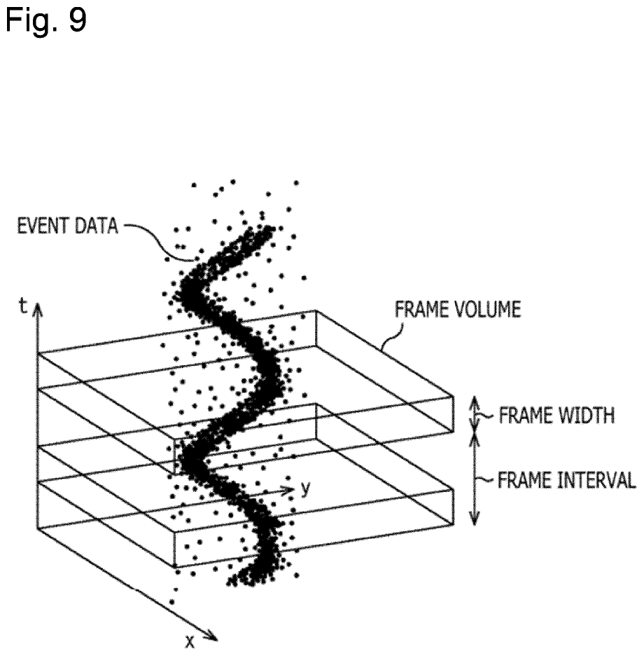

FIG. 9 is a diagram illustrating an example of a frame data generation method based on event data.

The logic section 22 sets a frame interval and a frame width on the basis of an externally input command, for example. Here, the frame interval represents the interval of frames of frame data that is generated on the basis of event data. The frame width represents the time width of event data that is used for generating frame data on a single frame. A frame interval and a frame width that are set by the logic section 22 are also referred to as a “set frame interval” and a “set frame width,” respectively.

The logic section 22 generates, on the basis of the set frame interval, the set frame width, and event data from the sensor section 21, frame data that is image data in a frame format, to thereby convert the event data to the frame data.

That is, the logic section 22 generates, in each set frame interval, frame data on the basis of event data in the set frame width from the beginning of the set frame interval.

Here, it is assumed that event data includes time point information ti indicating a time point at which an event has occurred (hereinafter also referred to as an “event time point”) and coordinates (x, y) serving as location information regarding (the pixel block 41 including) the pixel 51 in which the event has occurred (hereinafter also referred to as an “event location”).

In FIG. 9, in a three-dimensional space (time and space) with the x axis, the y axis, and the time axis t, points representing event data are plotted on the basis of the event time point t and the event location (coordinates) (x, y) included in the event data.

That is, when a location (x, y, t) on the three-dimensional space indicated by the event time point t and the event location (x, y) included in event data is regarded as the space-time location of an event, in FIG. 9, the points representing the event data are plotted on the space-time locations (x, y, t) of the events.

The logic section 22 starts to generate frame data on the basis of event data by using, as a generation start time point at which frame data generation starts, a predetermined time point, for example, a time point at which frame data generation is externally instructed or a time point at which the sensor device 10 is powered on.

Here, cuboids each having the set frame width in the direction of the time axis t in the set frame intervals, which appear from the generation start time point, are referred to as a “frame volume.” The size of the frame volume in the x-axis direction or the y-axis direction is equal to the number of the pixel blocks 41 or the pixels 51 in the x-axis direction or the y-axis direction, for example.

The logic section 22 generates, in each set frame interval, frame data on a single frame on the basis of event data in the frame volume having the set frame width from the beginning of the set frame interval.

Frame data can be generated by, for example, setting white to a pixel (pixel value) in a frame at the event location (x, y) included in event data and setting a predetermined color such as gray to pixels at other locations in the frame.

Besides, in a case where event data includes the polarity of a change in light amount that is an event, frame data can be generated in consideration of the polarity included in the event data. For example, white can be set to pixels in the case a positive polarity, while black can be set to pixels in the case of a negative polarity.

In addition, in the case where pixel signals of the pixels 51 are also output when event data is output as described with reference to FIG. 3 and FIG. 4, frame data can be generated on the basis of the event data by using the pixel signals of the pixels 51. That is, frame data can be generated by setting, in a frame, a pixel at the event location (x, y) (in a block corresponding to the pixel block 41) included in event data to a pixel signal of the pixel 51 at the location (x, y) and setting a predetermined color such as gray to pixels at other locations.

Note that, in the frame volume, there are a plurality of pieces of event data that are different in the event time point t but the same in the event location (x, y) in some cases. In this case, for example, event data at the latest or oldest event time point t can be prioritized. Further, in the case where event data includes polarities, the polarities of a plurality of pieces of event data that are different in the event time point t but the same in the event location (x, y) can be added together, and a pixel value based on the added value obtained by the addition can be set to a pixel at the event location (x, y).

Here, in a case where the frame width and the frame interval are the same, the frame volumes are adjacent to each other without any gap. Further, in a case where the frame interval is larger than the frame width, the frame volumes are arranged with gaps. In a case where the frame width is larger than the frame interval, the frame volumes are arranged to be partly overlapped with each other.

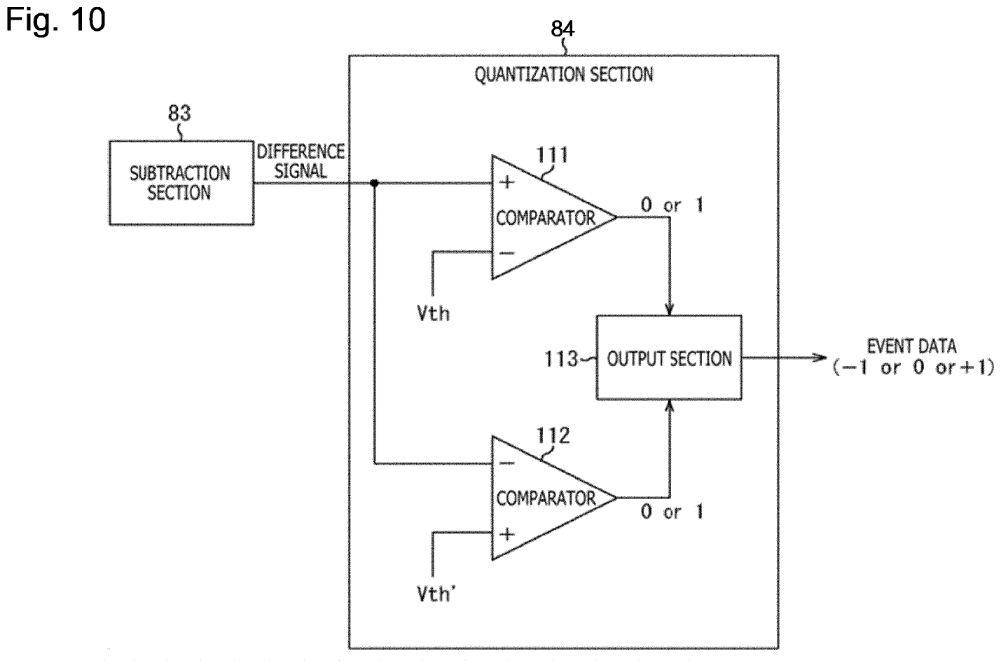

FIG. 10 is a block diagram illustrating another configuration example of the quantization section 84 of FIG. 5.

Note that, in FIG. 10, parts corresponding to those in the case of FIG. 7 are denoted by the same reference signs, and the description thereof is omitted as appropriate below.

In FIG. 10, the quantization section 84 includes comparators 111 and 112 and an output section 113.

Thus, the quantization section 84 of FIG. 10 is similar to the case of FIG. 7 in including the comparator 111. However, the quantization section 84 of FIG. 10 is different from the case of FIG. 7 in newly including the comparator 112 and the output section 113.

The event detecting section 52 (FIG. 5) including the quantization section 84 of FIG. 10 detects, in addition to events, the polarities of changes in light amount that are events.

In the quantization section 84 of FIG. 10, the comparator 111 outputs, in the case where a difference signal is larger than the threshold Vth, the H level indicating 1, as event data indicating the occurrence of an event having the positive polarity. The comparator 111 outputs, in the case where a difference signal is not larger than the threshold Vth, the L level indicating 0, as event data indicating that no event having the positive polarity has occurred.

Further, in the quantization section 84 of FIG. 10, a threshold Vth′ (<Vth) is supplied to the non-inverting input terminal (+) of the comparator 112, and difference signals are supplied to the inverting input terminal (−) of the comparator 112 from the subtraction section 83. Here, for the sake of simple description, it is assumed that the threshold Vth′ is equal to −Vth, for example, which needs however not to be the case.

The comparator 112 compares a difference signal from the subtraction section 83 with the threshold Vth′ applied to the inverting input terminal (−), thereby quantizing the difference signal. The comparator 112 outputs, as event data, the quantized value obtained by the quantization.

For example, in a case where a difference signal is smaller than the threshold Vth′ (the absolute value of the difference signal having a negative value is larger than the threshold Vth), the comparator 112 outputs the H level indicating 1, as event data indicating the occurrence of an event having the negative polarity. Further, in a case where a difference signal is not smaller than the threshold Vth′ (the absolute value of the difference signal having a negative value is not larger than the threshold Vth), the comparator 112 outputs the L level indicating 0, as event data indicating that no event having the negative polarity has occurred.

The output section 113 outputs, on the basis of event data output from the comparators 111 and 112, event data indicating the occurrence of an event having the positive polarity, event data indicating the occurrence of an event having the negative polarity, or event data indicating that no event has occurred to the transfer section 85.

For example, the output section 113 outputs, in a case where event data from the comparator 111 is the H level indicating 1, +V volts indicating +1, as event data indicating the occurrence of an event having the positive polarity, to the transfer section 85. Further, the output section 113 outputs, in a case where event data from the comparator 112 is the H level indicating 1, −V volts indicating −1, as event data indicating the occurrence of an event having the negative polarity, to the transfer section 85. In addition, the output section 113 outputs, in a case where each event data from the comparators 111 and 112 is the L level indicating 0, 0 volts (GND level) indicating 0, as event data indicating that no event has occurred, to the transfer section 85.

The transfer section 85 supplies a request to the arbiter 33 in the case where it is confirmed on the basis of event data from the output section 113 of the quantization section 84 that a change in light amount that is an event having the positive polarity or the negative polarity has occurred. After receiving a response indicating event data output permission, the transfer section 85 outputs event data indicating the occurrence of the event having the positive polarity or the negative polarity (+V volts indicating 1 or −V volts indicating −1) to the output section 35.

Preferably, the quantization section 84 has a configuration as illustrated in FIG. 10.

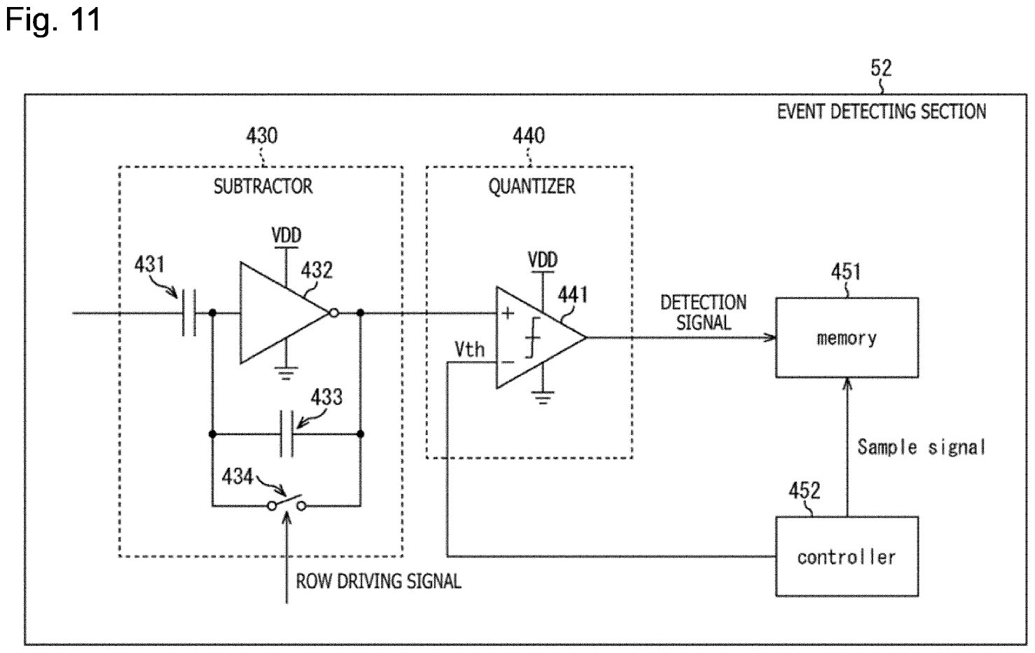

FIG. 11 is a diagram illustrating another configuration example of the event detecting section 52.

In FIG. 11, the event detecting section 52 includes a subtractor 430, a quantizer 440, a memory 451, and a controller 452. The subtractor 430 and the quantizer 440 correspond to the subtraction section 83 and the quantization section 84, respectively.

Note that, in FIG. 11, the event detecting section 52 further includes blocks corresponding to the current-voltage converting section 81 and the buffer 82, but the illustrations of the blocks are omitted in FIG. 11.

The subtractor 430 includes a capacitor 431, an operational amplifier 432, a capacitor 433, and a switch 434. The capacitor 431, the operational amplifier 432, the capacitor 433, and the switch 434 correspond to the capacitor 101, the operational amplifier 102, the capacitor 103, and the switch 104, respectively.

The quantizer 440 includes a comparator 441. The comparator 441 corresponds to the comparator 111.

The comparator 441 compares a voltage signal (difference signal) from the subtractor 430 with the predetermined threshold voltage Vth applied to the inverting input terminal (−). The comparator 441 outputs a signal indicating the comparison result, as a detection signal (quantized value).

The voltage signal from the subtractor 430 may be input to the input terminal (−) of the comparator 441, and the predetermined threshold voltage Vth may be input to the input terminal (+) of the comparator 441.

The controller 452 supplies the predetermined threshold voltage Vth applied to the inverting input terminal (−) of the comparator 441. The threshold voltage Vth which is supplied may be changed in a time-division manner. For example, the controller 452 supplies a threshold voltage Vth1 corresponding to ON events (for example, positive changes in photocurrent) and a threshold voltage Vth2 corresponding to OFF events (for example, negative changes in photocurrent) at different timings to allow the single comparator to detect a plurality of types of address events (events).

The memory 451 accumulates output from the comparator 441 on the basis of Sample signals supplied from the controller 452. The memory 451 may be a sampling circuit, such as a switch, plastic, or capacitor, or a digital memory circuit, such as a latch or flip-flop. For example, the memory 451 may hold, in a period in which the threshold voltage Vth2 corresponding to OFF events is supplied to the inverting input terminal (−) of the comparator 441, the result of comparison by the comparator 441 using the threshold voltage Vth1 corresponding to ON events. Note that, the memory 451 may be omitted, may be provided inside the pixel (pixel block 41), or may be provided outside the pixel.

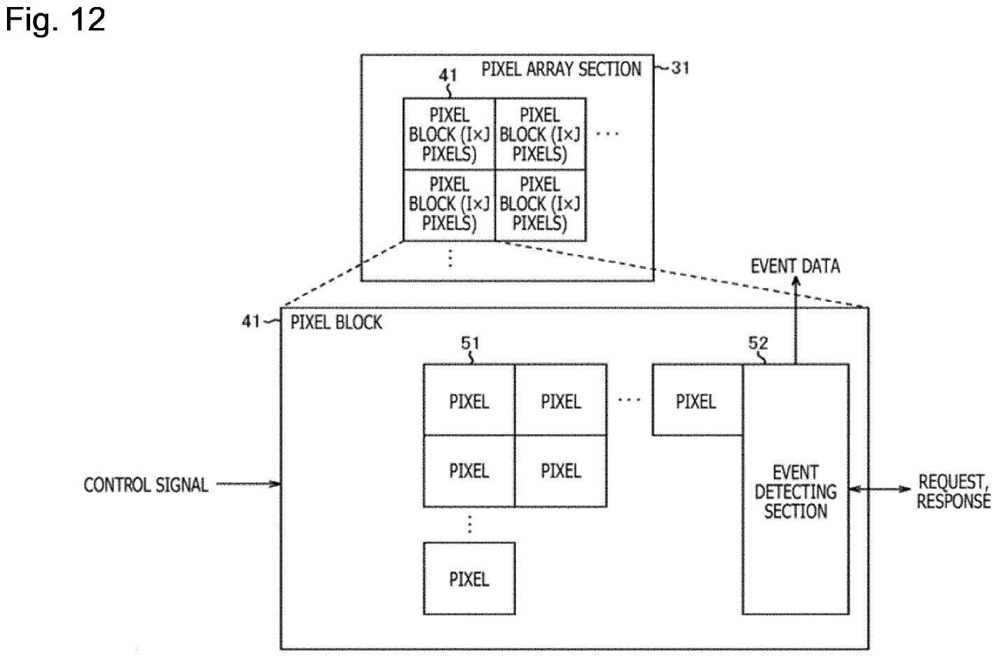

FIG. 12 is a block diagram illustrating another configuration example of the pixel array section 31 of FIG. 2.

Note that, in FIG. 12, parts corresponding to those in the case of FIG. 3 are denoted by the same reference signs, and the description thereof is omitted as appropriate below.

In FIG. 12, the pixel array section 31 includes the plurality of pixel blocks 41. The pixel block 41 includes the I×J pixels 51 that are one or more pixels and the event detecting section 52.

Thus, the pixel array section 31 of FIG. 12 is similar to the case of FIG. 3 in that the pixel array section 31 includes the plurality of pixel blocks 41 and that the pixel block 41 includes one or more pixels 51 and the event detecting section 52. However, the pixel array section 31 of FIG. 12 is different from the case of FIG. 3 in that the pixel block 41 does not include the pixel signal generating section 53.

As described above, in the pixel array section 31 of FIG. 12, the pixel block 41 does not include the pixel signal generating section 53, so that the sensor section 21 (FIG. 2) can be formed without the AD conversion section 34.

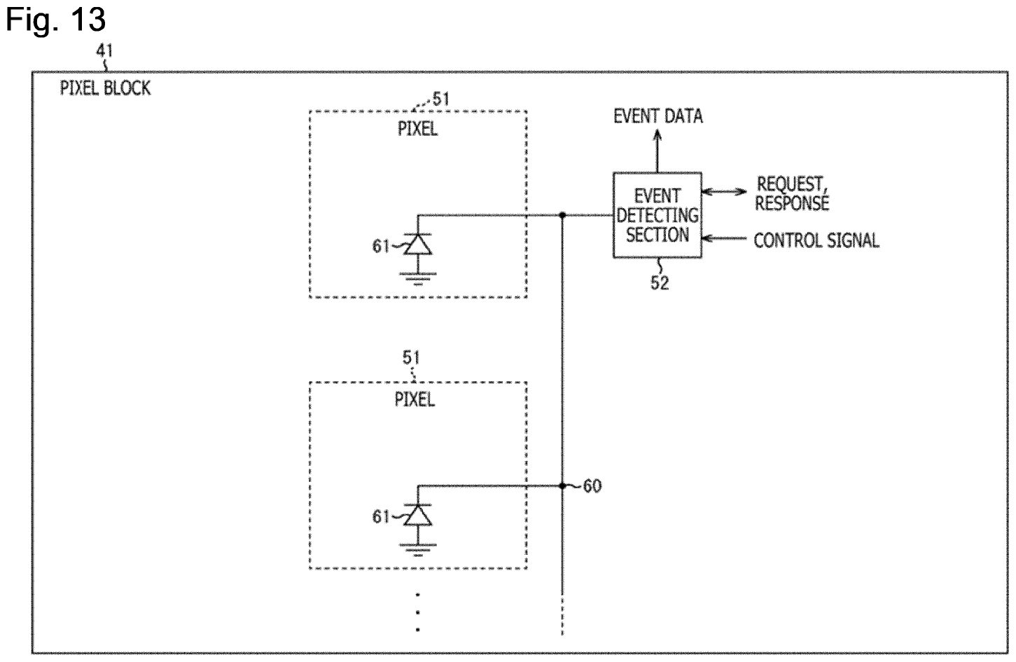

FIG. 13 is a circuit diagram illustrating a configuration example of the pixel block 41 of FIG. 12.

As described with reference to FIG. 12, the pixel block 41 includes the pixels 51 and the event detecting section 52, but does not include the pixel signal generating section 53.

In this case, the pixel 51 can only include the photoelectric conversion element 61 without the transfer transistors 62 and 63.

Note that, in the case where the pixel 51 has the configuration illustrated in FIG. 13, the event detecting section 52 can output a voltage corresponding to a photocurrent from the pixel 51, as a pixel signal.

Above, the sensor device 10 was described to be an asynchronous imaging device configured to read out events by the asynchronous readout system. However, the event readout system is not limited to the asynchronous readout system and may be the synchronous readout system. An imaging device to which the synchronous readout system is applied is a scan type imaging device that is the same as a general imaging device configured to perform imaging at a predetermined frame rate.

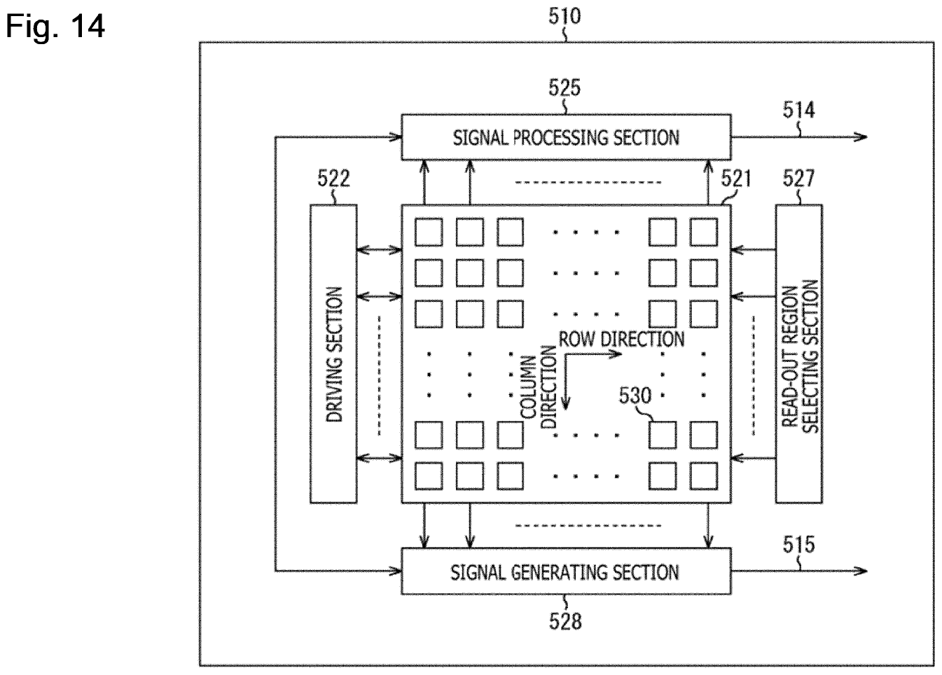

FIG. 14 is a block diagram illustrating a configuration example of a scan type imaging device, i.e. of a sensor device functioning as active pixel sensor, APS.

As illustrated in FIG. 14, an imaging device 510 includes a pixel array section 521, a driving section 522, a signal processing section 525, a read-out region selecting section 527, and a signal generating section 528.

The pixel array section 521 includes a plurality of pixels 530. The plurality of pixels 530 each output an output signal in response to a selection signal from the read-out region selecting section 527. The plurality of pixels 530 can each include an in-pixel quantizer as illustrated in FIG. 11, for example. The plurality of pixels 530 output signals corresponding to the amounts of change in light intensity. The plurality of pixels 530 may be two-dimensionally disposed in a matrix as illustrated in FIG. 14.

The driving section 522 drives the plurality of pixels 530, so that the pixels 530 output pixel signals generated in the pixels 530 to the signal processing section 525 through an output line 514. Note that, the driving section 522 and the signal processing section 525 are circuit sections for acquiring grayscale information. Thus, in a case where only event information (event data) is acquired, the driving section 522 and the signal processing section 525 may be omitted. On the other hand, when event detection is not required, all sections not necessary for acquisition of grayscale information may be omitted.

The read-out region selecting section 527 selects some of the plurality of pixels 530 included in the pixel array section 521. For example, the read-out region selecting section 527 selects one or a plurality of rows included in the two-dimensional matrix structure corresponding to the pixel array section 521. The read-out region selecting section 527 sequentially selects one or a plurality of rows on the basis of a cycle set in advance. Further, the read-out region selecting section 527 may determine a selection region on the basis of requests from the pixels 530 in the pixel array section 521.

The signal generating section 528 generates, on the basis of output signals of the pixels 530 selected by the read-out region selecting section 527, event signals corresponding to active pixels in which events have been detected of the selected pixels 530. The events mean an event that the intensity of light changes. The active pixels mean the pixel 530 in which the amount of change in light intensity corresponding to an output signal exceeds or falls below a threshold set in advance. For example, the signal generating section 528 compares output signals from the pixels 530 with a reference signal, and detects, as an active pixel, a pixel that outputs an output signal larger or smaller than the reference signal. The signal generating section 528 generates an event signal (event data) corresponding to the active pixel.

The signal generating section 528 can include, for example, a column selecting circuit configured to arbitrate signals input to the signal generating section 528. Further, the signal generating section 528 can output not only information regarding active pixels in which events have been detected, but also information regarding non-active pixels in which no event has been detected.

The signal generating section 528 outputs, through an output line 515, address information and timestamp information (for example, (X, Y, T)) regarding the active pixels in which the events have been detected. However, the data that is output from the signal generating section 528 may not only be the address information and the timestamp information, but also information in a frame format (for example, (0, 0, 1, 0, . . . )).

In the following description reference will mainly be made to sensor devices of the EVS type as described above in order to ease the description and to cover an important application example. However, the principles explained below apply just as well to sensor devices of the APS type or to hybrid EVS/APS systems.

FIG. 15 is a schematic block diagram of a sensor device 10 that can be used to capture a scene while concurrently using different values for specific imaging parameters.

The sensor device 10 comprises a plurality of pixels 51, which are preferably, but not necessarily, arranged in a two-dimensional array. Each pixel 51 is configured to receive light and perform photoelectric conversion to generate an electrical signal. The pixels 51 are connected with circuitry 20 that is configured to generate image data from the electrical signals based on imaging parameters that are adjustable for each pixel 51.

The circuitry 20 may be configured to generate as image data event data that indicate intensity changes above an event detection threshold of the light. The sensor device operates then as an EVS/DVS as described above. The adjustable imaging parameter for such an EVS may for example be the event detection threshold (if necessary different for positive and negative polarity events), pixel bandwidth, a refractory period during which a pixel 51 is inert after event detection, or the like. Each of these imaging parameters affects the rate of and/or the sensitivity for event detection, and thus the final imaging result.

For example, using a low event detection threshold will lead to fast and sensitive event detection, since more signal-related events are detected. But a low event detection threshold will on the other hand also lead to a low SNR, since the probability to detect noise instead of a true event rises, the lower the event detection threshold gets. On the other hand, when using a larger event detection threshold, event detection will be slower and less sensitive, but will have a better signal to noise ratio.

The pixel bandwidth is adjustable e.g. via a front end bias voltage (e.g. Vbias at transistor 92 of FIG. 6), a buffer bias or an amplifier bias. For low bandwidths, i.e. low currents, the SNR will improve, since there is less bandwidth to integrate noise, but the temporal resolution will be reduced, since fast motions are lost or attenuated, and vice versa for high bandwidths.

The refractory periods of the single pixels 51 can also be varied e.g. to reduce data rates in areas of high or redundant event activities for long refractory periods and to increase event detection rates for short refractory periods.

Of course, it is to be understood that these are mere examples and that also other imaging parameters could be adjustable via the circuitry 20. In fact, any parameter can be used that has a direct or indirect influence on the outcome of the imaging.

Just the same, the circuitry 20 may be configured to generate as image data pixel signals indicating intensity values of the received light for each pixel 51, i.e. the circuitry 20 allows to operate the sensor device 10 (additionally or alternatively) as a conventional APS that captures frames showing the intensity of the light received at all pixels 51 during a pixel exposure time.

In this case, the adjustable imaging parameter may include the pixel exposure time, a pixel signal offset, a pixel gain setting, or the like. The exposure time might be adjustable by using multiple clocks per row and/or column, which could e.g. be generated from a master clock and a clock divider. The offset of the pixel value might be adjustable via a source follower bias current, while the gain setting is adjustable via the amplifier setting applied to the read out signal. Also by adjusting these imaging parameters sensitivity is traded vs. noise.

The sensor device 10 further comprises a control unit 30 that is configured to divide for each of a series of specific time periods the plurality of pixels 51 into at least a first subset S1 of pixels 51 and a second subset S2 of pixels, and to set for the specific time period to the pixels 51 of each subset S1, S2 a different parameter value of at least one of the imaging parameters. In particular, the control unit 30 dictates the circuitry 20 for every pixel 51 which value is to be set for which imaging parameter. To this end, the control unit 30 may be any kind of processing unit, circuitry, hardware, software or a mixture thereof that is capable to carry out the functions of the control unit 30 discussed herein.

In the example shown in FIG. 15 the control unit 30 controls the circuitry 20 to set one imaging parameter, like e.g. the event detection threshold, in a first subset S1 of pixels 51 (hatched in FIG. 15) to a first value, while the one imaging parameter is set to a different, second value in a second subset S2 of pixels 51 (blank in FIG. 15). In principle, it is also possible to set different parameter values to each pixel to adjust the values of more than one imaging parameter at the same time, and to use more than two pixel subsets S1, S2. However, for the ease of description in the following it will often be assumed that the pixels 51 are divided into two subsets S1, S2 in which all pixels 51 have a first parameter value and a second parameter value, respectively, of one of the available imaging parameters.

As schematically illustrated in FIG. 15 the circuitry 20 may include row setting lines 23 and column setting lines 24. Each pixel 51 is connected to a different pair of row setting line 23 and column setting line 24, which allows generating of different image parameter adjusting signals for each pixel by combining adjusting signals fed into the respective row setting lines 23 and column setting lines 24. For example, bias voltages and/or currents used in the pixels 51 can be adjusted by applying according voltages/currents to the row setting lines 23 and the column setting lines 24 and by using bias generators as known to a skilled person.

Thus, in principle, parameter values can be freely adjusted across the pixels 51. This allows the control unit 30 to set specific parameter values to each of the pixels during specific time periods and to change the parameter values at the end of each time period. The specific time periods may depend on image capturing parameters like frame rates or the like. The specific time periods may also depend on a change of the type of captured scene or a similar trigger that brings the control unit 30 to a reassignment of parameter values. The specific time periods may also have a predetermined, fixed length, which leads to a periodic update of the assigned imaging parameter values.

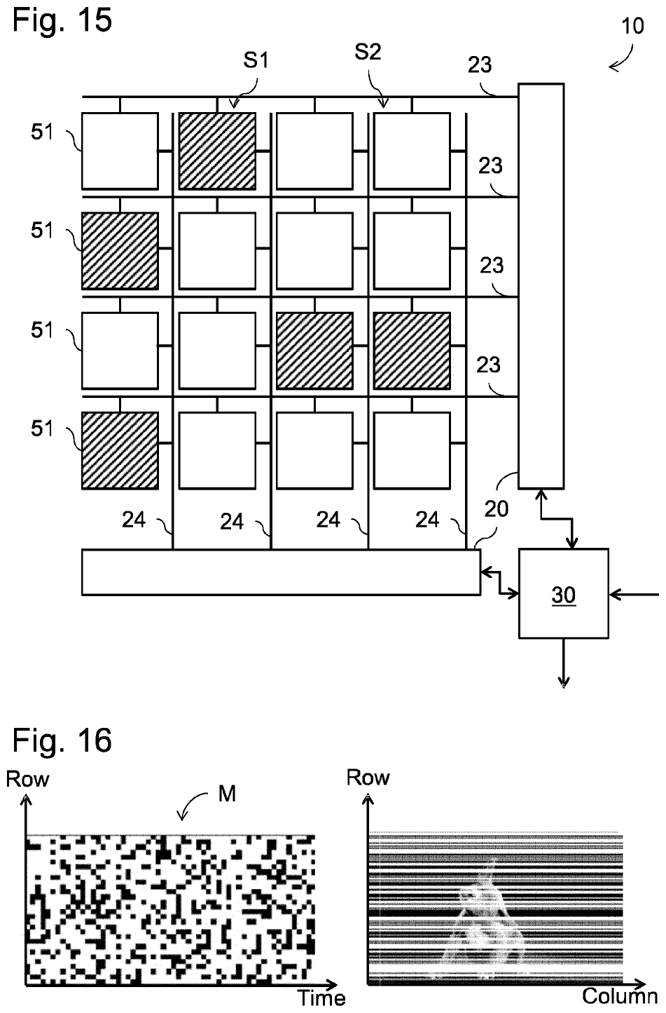

FIG. 16 shows schematically a coding scheme for dividing the plurality of pixels 51 row-wise into a first subset S1 having a first parameter value and a second subset S2 having a second parameter value. As shown on the left hand side of FIG. 16 during each specific time period (which corresponds here exemplarily to one clock cycle) the division into the two subsets is newly made. For example, the control unit 30 may indicate with a set flag or a bit value of “1”, which is represented by a black dot in FIG. 16, that the first parameter value is to be set in the respective row, while a non-set flag or a bit value of “0”, represented by a white dot in FIG. 16, triggers setting of the second parameter value in the respective row.

Thus, for each of the specific time periods a part of the pixel rows is able to generate image data by using the first parameter value. This corresponds to the ability to capture a part of the scene as illustrated on the right hand side of FIG. 16 by using the first parameter value, while the rest of the scene is captured with the second parameter value. In the next time step, the assignment changes, such that different parts of the scene are captured with the first and second parameter values, respectively.

The information captured during each specific time period for each pixel subset S1, S2 allows in principle reconstruction of the entire scene. In particular, since during a series of consecutive time periods most likely all pixels are operated with all parameter values at least once, the time series of the (partial) image data of each subset can be used to generate a series of image data of the entire scene for each parameter value. Moreover, temporal video regularities such as the absence of flickering in natural videos give additional constraints for image reconstruction.

Here, it is to be understood that the row-wise division is merely exemplarily. Also a column-wise or pixel-wise division can be applied, e.g. by using the row setting lines 23 and the column setting lines 24 or only the column setting lines 24.

The control unit 30 is configured to gather the image data obtained via all subsets S1, S2 of pixels 51 during the specific time period and to generate final images F by using the image data. As explained above, during each of the specific time periods the sensor device 10 captures different parts of the scene by applying different parameter values of at least one imaging parameter. Since the pixel subsets S1, S2 provide a representation of the scene that allows in principle to reconstruct the whole scene, one obtains a set of information that is equivalent to the information provided when capturing the scene with multiple sensor devices to which the different parameter values are set. Thus, although using only a single sensor device 10 and although the image capturing period is not extended, it is possible to generate final images F as if several sensor devices were used. This improves the quality of the final images compared to images obtained by using only a single parameter value.

In this process the control unit 30 may also rely on information about the division of the plurality of pixels into the different subsets S1, S2 of pixels 51, e.g. in the form of a coding scheme or mask as illustrated in FIG. 16. For example, the control unit 30 stores flag or bit values used to control the circuitry 20 together with the image data output during the respective specific time period. Just the same, the circuitry 20 may output together with the image data of each pixel an indicator showing which parameter value(s) were used. In particular, if an EVS is used, detected events will be indicated by providing spatial location, temporal location, (optionally) polarity, and a parameter value indicator, like e.g. a bit string encoding the parameter values of the adjustable imaging parameters.

In this manner, the control unit 30 knows which part of the received image data was generated with which imaging setting. This will improve the reconstruction quality for the generation of the final images.

As explained above tuning imaging parameter values into one direction leads to an improvement of the captured image in one regard, while deterioration in another regard must be accepted. To mitigate this problem the control unit may be configured to set the different parameter values such as to cause such complementary reconstruction properties for image data generation in the different subsets S1, S2.

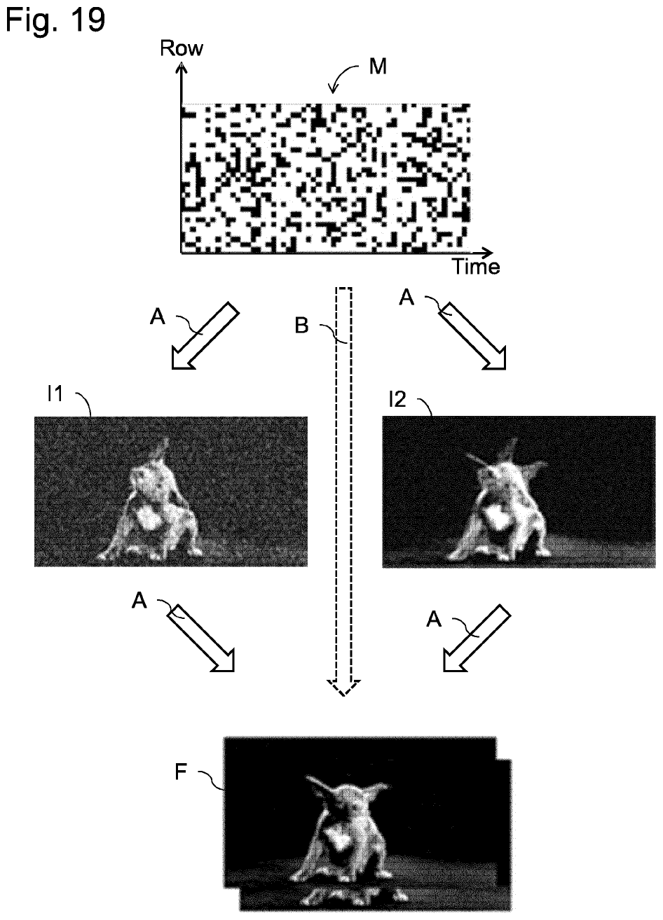

For example, the control unit may set a comparably low event detection threshold in a first subset S1 of pixels 51 and a comparably high event detection threshold in a second subset S2 of pixels 51. This will lead to comparably high temporal resolution image data having a comparably low SNR in the first subset S1, while the image data of the second subset S2 has a comparably low temporal resolution and a comparably high SNR. A pair of resulting images is shown in the middle part of FIG. 19, where the left hand side shows an image reconstructed from a low event detection threshold subset and the right hand side shows an image reconstructed from a high event detection threshold subset. It can be seen that the right hand side image has a low noise level, but no sufficient temporal resolution to avoid motion blur, while the left hand side image has more noise, but no motion blur.

By applying one (or more) such complementary reconstruction properties to different subsets of the pixels it is possible to correct the deficiencies present in the one image representation with the other image representation and vice versa. Accordingly, the resulting final images F will show neither the deficiencies of the one image representation nor of the other (or shows these deficiencies only in attenuated form), as e.g. shown in the bottom part of FIG. 19.

As indicated schematically and exemplarily on the left hand side of FIG. 16, the control unit 30 may be configured to perform the division of the plurality of pixels 51 into the subsets S1, S2 of pixels 51 randomly. In particular, the control unit 30 may comprise a random number generator whose output for each pixel, row, or column determines the parameter value to be set. As shown in FIG. 16, flag or bit values (represented by black and white dots) may be set at the beginning of each specific time period according to the output of a random number generator, having e.g. an output of “0s” and “1s”. Since the assignment to which pixel subset each pixel belongs is made on a random basis, it is ensured that the image capturing is not biased to a specific parameter value distribution.

However, the assignment of pixels 51 to specific subsets, or, differently stated, the assignment of parameter values to pixels 51, rows, or columns may not or not completely be random. The control unit 30 may also be configured to perform the division of the plurality of pixels 51 into the subsets S1, S2 of pixels 51 at consecutive points in time based on an evaluation of previously generated final images F. In particular, the control unit 30 is able to determine from the previously generated final images F how to assign parameter values to the pixels 51. Here, the control unit 30 may either set general criteria for assigning the parameter values, such as a bias to a random number generator or may specifically set the parameter values of each of the pixels 51 based on the evaluation of the previously generated final images F.

In this manner, the control unit 30 is capable to adapt the assignment of imaging parameter values to specific conditions, like e.g. particularly bright or dark light conditions or the capturing of fast moving objects. This will improve the quality of the newly generated final images F.

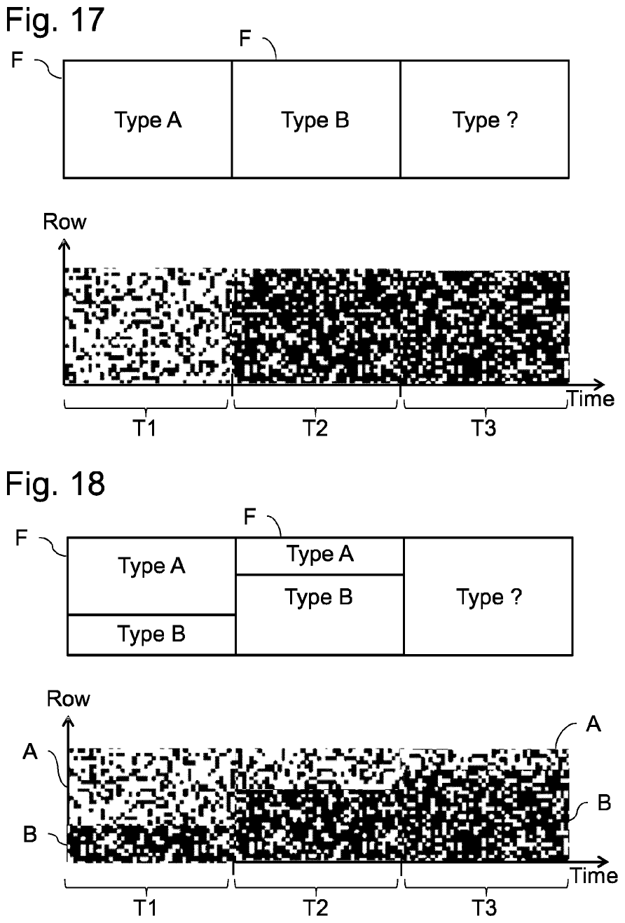

As schematically shown in FIG. 17 the control unit 30 may be configured to change the pixel ratio of the number of pixels 51 in the different subsets S1, S2 based on the evaluation of the previously generated final images F. Here, during a first period T1, scenes of a first specific type, indicated as Type A, are captured. In this first period T1 parameter values are randomly assigned to pixels (represented in FIG. 17 exemplarily as row-wise assignment) with the boundary condition that the (if necessary temporally averaged) ratio of the number of pixels 51 in the first subset S1 to the number of pixels in the second subset S2 has a specific value. This may e.g. be achieved by randomly selecting only a given number pixels 51 to have a specific parameter value or by specifically choosing a set of pixels 51 to have the specific parameter value.

After period T1 a second period T2 follows in which a different scene type is observed, indicated as Type B. The control unit 30 is capable to determine the change of scene type after the period T1 and to change the number ratio of the pixels 51 in the different subsets. As indicated in FIG. 17 during the period T2 the number of pixels 51 assigned to the first subset S1 may be increased, while the distribution of according parameter values across the pixels 51 is still carried out randomly.

Finally, when image acquisition has exemplarily reached the end of period T2, the control unit 30 has to decide how to divide the pixels 51 in the future. To this end, the control unit 30 evaluates which scene types have been observed in the past (i.e. Type A and Type B) and deduces which scene type will be most probable in the future, represented in FIG. 17 by period T3. Then, the control unit 30 adjusts the assignment of parameter values to the pixels 51 accordingly.

In the example of FIG. 17, it is expected that also in period T3 scenes of Type B will be observed. Thus, the assignment of parameter values is continued as in period T2.

As illustrated in FIG. 18 this procedure can be extended such that the control unit 30 is configured to also segment the plurality of pixels 51 into different areas based on the evaluation of the previously generated final images F, and to divide the pixels 51 in different areas according to different pixel ratios. Thus, the prediction which scheme of parameter value assignment is to be used for which pixels is extended from a purely temporal prediction to a spatiotemporal prediction.

This is schematically shown in FIG. 18 for a row-wise parameter value assignment. During period T1 a larger part of the final images F is of Type A, while a smaller part is of Type B. To deal with this situation the pixels 51 are grouped into corresponding areas A and B, in which different parameter value assignment schemes are applied. In the example of FIG. 18 the pixel rows in area A are divided into the first and the second subset according to a first number ratio, while for the rows in area B a different, second number ratio is used.

Period T1 is followed by period T2, in which the part of the scene that is of Type B has increased within the final images F. Accordingly, also the area B in which the second number ratio is used has increased. Which parameter value assignment schemes are used best for which pixel areas for future image capturing in period T3 is predicted based on the final images F generated during periods T1 and T2. This is exemplarily indicated in FIG. 18 by a further extension of the area B in which division according to the second number ratio is applied, since it can be expected from the final images F captured during periods T1 and T2 that the part of the scene belonging to type B further increases.

It has to be noted that the above separation into periods T1, T2, and T3 is exemplary and that the evaluation of the previously generated final images is performed continuously by the control unit 30 such as to allow an adaption of the parameter value adjustment scheme at least in each of the specific time periods after which the parameter adjustment is changed anyhow. Thus, periods T1, T2 and T3 of FIGS. 17 and 18 might in fact have only a length of one or several specific time periods which are represented in FIGS. 17 and 18 by the temporal lengths of the black and white dots.

The control unit 30 may evaluate the previously generated final images by using rule based algorithms that are e.g. able to recognize bright and dark parts or specific objects within an image. The adjustment of parameter values might then follow rules based on the recognized contents within the images. For example, for five mostly dark final images, it may be expected that also the next image will be dark. Further, for a fast moving object the speed may be deduced and pixels 51 corresponding to the expected position of the objection may be set to fitting imaging parameter values such as a low event detection threshold.

Preferably, the control unit 30 is configured to evaluate the previously generated final images F by using a neuronal network that directly provides coded information for assigning parameter values (e.g. in the form of flags or bit strings) in the next time step based on the image data provided from the pixels 51 in the previous time step.

Intuitively, such a network shall detect the scene type being imaged (e.g. cloudy day/night) and then infer an optimal parameter value assignment for the next frame(s). This will also help to improve the image quality. The training of such network can be achieved by using a simulator of the image capturing properties of the sensor device that produces image data from different pixels subsets based on known images.

Here, the output of the neuronal network may either be a direct assignment of parameter values, i.e. a coding scheme as shown in FIGS. 16 to 18 that is, however, not produced by a random number generator, but at once by the neuronal network. Alternatively, the neuronal network may also only set the framework for the application of a random number generator, such as the number ratio to be reached.

As explained above, the principle idea for improving the image quality is to combine the image data generated based on signals of pixels 51 belonging to different pixel subsets to which different imaging parameter values are assigned.

In this process, the control unit 30 may be configured to generate for each of the specific time periods predetermined intermediate images I1, I2 for each subset S1, S2 of pixels 51 by using the image data generated by the pixels 51 of the respective subset S1, S2 of pixels 51. The final images F are then generated by fusing intermediate images I1, I2 of different subsets S1, S2 of pixels 51.

This is exemplarily and schematically illustrated in FIG. 19. At the top of FIG. 19 a coding scheme/mask is shown that assigns one of two parameter values to each pixel row, e.g. a comparably low event detection threshold and a comparably high event detection threshold.

From the image data obtained from pixels 51 using the one parameter value a first intermediate image I1 can be generated, e.g. by interpolating pixel values for pixels 51 belonging to the other subset. Just the same a second intermediate image I2 is generated from the image data of the pixels 51 using the other parameter value. The information of the respectively formed intermediate images I1, I2 is then used to improve the other image until possible deficiencies can be removed and the corresponding final image F is generated.

In the example of FIG. 19 the low event detection threshold leads to the noisy first intermediate image I1, which has, however, a high temporal resolution. The high event detection threshold leads to the second intermediate image I2 that has a low noise level, but less temporal resolution which leads to motion blur. The final image F can then e.g. be obtained by identifying a specific time slice in the motion blurred second intermediate image I2 by using the temporally well-defined first intermediate image I1. This time slice is then in turn used to identify and remove noise from the first intermediate image I2. In this manner a final image F with reduced noise and reduced motion blur can be obtained, which would not have been possible with just one value of the event detection threshold.

According to the above described principles also more than two subsets of pixels 51 can be formed leading to more than two intermediate images that can then be fused using in principle known algorithms to produce a final image having the benefits of all image data captured with the differing image parameter values.

In FIG. 19 the above process follows the processing path indicated by arrows A. The same result can also be obtained by the control unit 30 by using an artificial intelligence model that receives the image data obtained via the at least two subsets S1, S2 of pixels 51 during the specific time period and that outputs the final images F directly. This is symbolized by arrow B in FIG. 19. The used artificial intelligence model may be a model-aware neural network designed to optimally decode and fuse images. Such model-aware neural networks are described e.g. in “Deep variational network for rapid 4D flow MRI reconstruction” by Vishnevskiy V, Walheim J, Kozerke S. (Nat Mach Intell 2, 228-235 (2020). https://doi.org/10.1038/s42256-020-0165-6) and “Deep variational networks with exponential weighting for learning computed tomography” by Vishnevskiy V, Rau R, Goksel O (In: Shen D. et al. (eds) Medical Image Computing and Computer Assisted Intervention—MICCAI 2019; MICCAI 2019; Lecture Notes in Computer Science, vol 11769. Springer, Cham. https://doi.org/10.1007/978-3-030-32226-7_35), which are incorporated for reference here as far as model-aware neural networks are concerned.

In this manner the generation of final image F can be achieved with low processing burden once a sufficiently trained artificially intelligence model is implemented in the control unit 30. Again, the model can be trained by using a simulation of the sensor device 10.

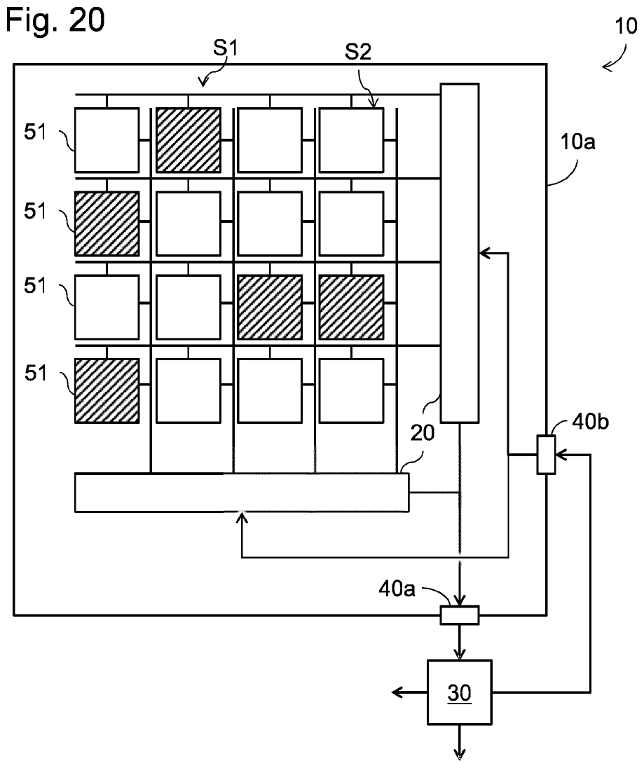

As illustrated in FIG. 20 the pixels 51 and the circuitry 20 may be arranged on a sensor chip 10a as is in principle known to a skilled person. However, instead of having only a single (first) port 40a for outputting the image data from the sensor chip 10a, the sensor chip 10a may comprise a second port 40b for inputting control information like a coding scheme for controlling the division of the plurality of pixels 51 into the at least two subsets S1, S2 of pixels 51 and the parameter values of the at least one imaging parameter.

In this configuration the control unit 30 is arranged outside the sensor chip 10a, e.g. on a different chip or in an external device. The control unit 30 receives the image data and, if necessary, the assignment of parameter values to pixels 51 to generate the final images. Further, the control unit 30 produces the control information that assigns the pixels 51 to the different subsets S1, S2, like e.g. the output of the (biased) random number generator or a fixed coding scheme, which is fed via the second port 40b to the circuitry to set therein the desired values of the imaging parameters. Of course, the control unit 30 could also be located on the sensor chip 10a. In this case, the second port 40b could be used to connect an external random number generator to the control unit 30 that uses the generated random numbers to divide the pixels 51 into the various subsets S1, S2.

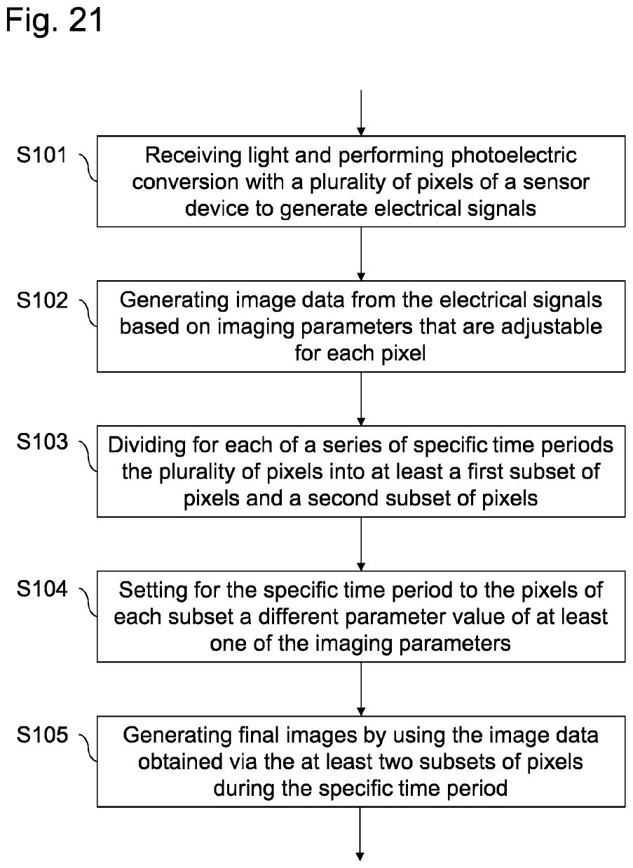

Above various implementations of the basic idea to capture an image by using simultaneously different imaging parameter values in a single pixel array has been discussed. The basic method underlying all these implementations is again summarized below with respect to FIG. 21.

Here, at S101 light is received and photoelectric conversion is performed with a plurality of pixels 51 of the sensor device 10 to generate an electrical signal.

At S102 circuitry 20 of the sensor device 10 is used to generate image data from the electrical signals based on imaging parameters that are adjustable for each pixel 51.

At S103 for each of a series of specific time periods the plurality of pixels 51 are divided into at least a first subset S1 of pixels 51 and a second subset S2 of pixels 51.

At S104 for each specific time period a different parameter value of at least one of the imaging parameters is set to the pixels 51 of each subset S1, S2.

At S105 final images F are generated by using the image data obtained via the at least two subsets S1, S2 of pixels 51 during the respective specific time period.

Thus, the basic idea is to obtain the information available for different imaging parameter values within a single capturing period and to deduce therefrom a final image that does not show the deficiencies that are produced when only a single imaging parameter value is applied. In this manner the quality of the capture images/the captured video stream can be improved.

The technology according to the above (i.e. the present technology) is applicable to various products. For example, the technology according to the present disclosure may be realized as a device that is installed on any kind of moving bodies, for example, vehicles, electric vehicles, hybrid electric vehicles, motorcycles, bicycles, personal mobilities, airplanes, drones, ships, and robots.

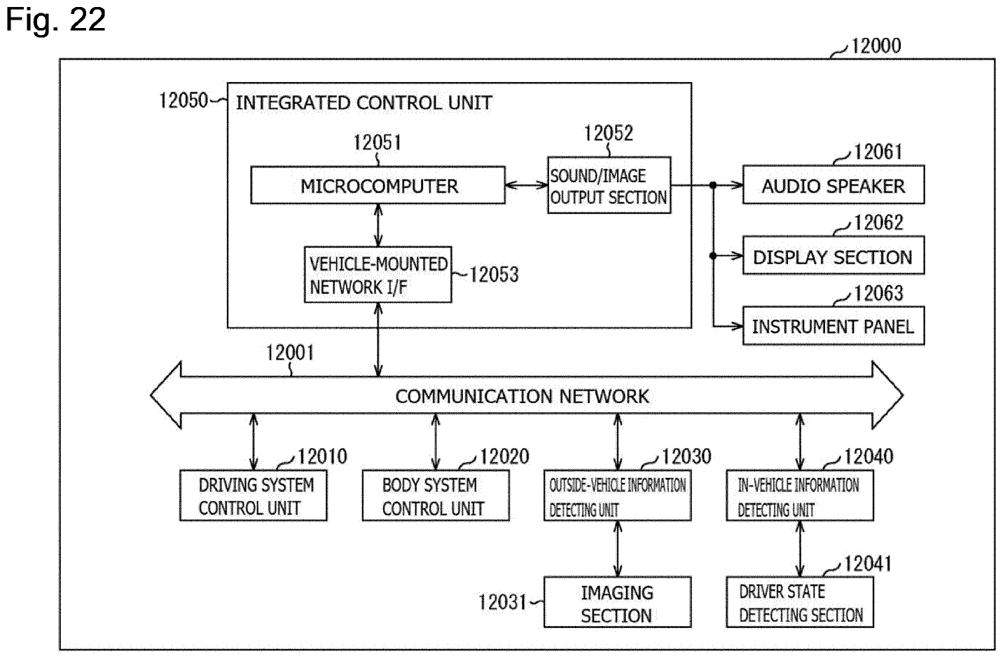

FIG. 22 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 22, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automatic driving, which makes the vehicle to travel autonomously without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 22, an audio speaker 12061, a display section 12062, and an instrument panel 12063 are illustrated as the output device. The display section 12062 may, for example, include at least one of an on-board display and a head-up display.

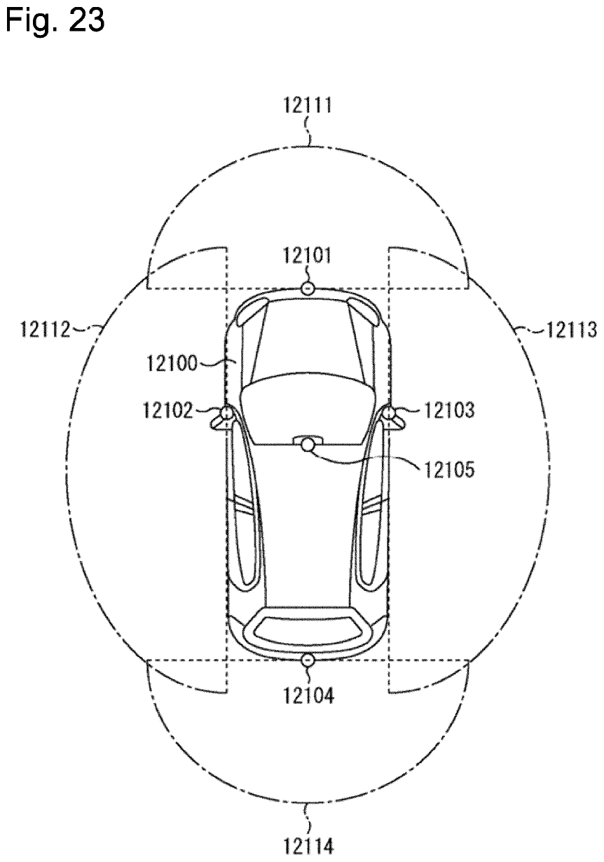

FIG. 23 is a diagram depicting an example of the installation position of the imaging section 12031.

In FIG. 23, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 23 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automatic driving that makes the vehicle travel autonomously without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure is applicable has been described above. The technology according to the present disclosure is applicable to the imaging section 12031 among the above-mentioned configurations. Specifically, the sensor device 10 is applicable to the imaging section 12031. The imaging section 12031 to which the technology according to the present disclosure has been applied flexibly acquires event data and performs data processing on the event data, thereby being capable of providing appropriate driving assistance.

Note that, the embodiments of the present technology are not limited to the above-mentioned embodiment, and various modifications can be made without departing from the gist of the present technology.

Further, the effects described herein are only exemplary and not limited, and other effects may be provided.

Note that, the present technology can also take the following configurations.

1. A sensor device comprising:
a plurality of pixels each configured to receive light and perform photoelectric conversion to generate an electrical signal;
circuitry configured to generate image data from the electrical signals based on imaging parameters that are adjustable for each pixel;
a control unit that is configured to divide for each of a series of specific time periods the plurality of pixels into at least a first subset of pixels and a second subset of pixels, to set for each specific time period to the pixels of each subset a different parameter value of at least one of the imaging parameters, and to generate final images by using the image data obtained via the at least two subsets of pixels during the respective specific time period.

2. The sensor device according to 1, wherein
the control unit is configured to generate the final image also based on information about the division of the plurality of pixels into the different subsets of pixels.

3. The sensor device according to any one of 1 and 2, wherein
the control unit is configured to set the different parameter values such as to cause complementary reconstruction properties for image data generation in the different subsets.

4 The sensor device according to any one of 1 to 3, wherein
the control unit is configured to perform the division of the plurality of pixels into the subsets of pixels randomly.

5. The sensor device according to any one of 1 to 4, wherein
the control unit is configured to perform the division of the plurality of pixels into the subsets of pixels at consecutive points in time based on an evaluation of previously generated final images.

6. The sensor device according to 5, wherein
the control unit is configured to change the pixel ratio of the number of pixels in the different subsets based on the evaluation of the previously generated final images.

7. The sensor device according to 6, wherein
the control unit is configured to segment the plurality of pixels into different areas based on the evaluation of the previously generated final images, and to divide the pixels in different areas according to different pixel ratios.

8. The sensor device according to any one of 5 to 8, wherein
the control unit is configured to evaluate the previously generated final images by using a neuronal network.

9. The sensor device according to any one of 1 to 8, wherein
the control unit is configured to generate during each specific time period predetermined intermediate images for each subset of pixels by using the image data generated by the pixels of the respective subset of pixels, and to generate the final images by fusing intermediate images of different subsets of pixels.

10. The sensor device according to any one of 1 to 8, wherein
the control unit is configured to generate the final images by using an artificial intelligence model that receives the image data obtained via the at least two subsets of pixels during each specific time period and that outputs the final images.

11. The sensor device according to any one of 1 to 10, wherein
the circuitry is configured to generate as image data event data that indicate intensity changes above an event detection threshold of the light; and
the at least one imaging parameter is one of the event detection threshold, a pixel bandwidth, and a refractory period during which a pixel is inert after event detection.

12. The sensor device according to any one of 1 to 11, wherein
the circuitry is configured to generate as image data pixel signals indicating intensity values of the received light for each pixel; and
the at least one imaging parameter is one of pixel exposure time, pixel signal offset and pixel gain setting.

13. The sensor device according to any one of 1 to 12, further comprising
a sensor chip on which the pixels and the circuitry are arranged; wherein
the sensor chip comprises a first port for outputting the image data from the sensor chip, and a second port for inputting control information for controlling the division of the plurality of pixels into the subset of pixels and the parameter values of the at least one imaging parameter.

14. A method for operating a sensor device, the method comprising:
receiving light and performing photoelectric conversion with a plurality of pixels of the sensor device to generate an electrical signal;
generating with circuitry of the sensor device image data from the electrical signals based on imaging parameters that are adjustable for each pixel;
dividing for each of a series of specific time periods the plurality of pixels into at least a first subset of pixels and a second subset of pixels;
setting for each specific time period to the pixels of each subset a different parameter value of at least one of the imaging parameters; and
generating final images by using the image data obtained via the at least two subsets of pixels during the respective specific time period.

1. A sensor device comprising:
a plurality of pixels each configured to receive light and perform photoelectric conversion to generate an electrical signal;
circuitry configured to generate image data from the electrical signals based on imaging parameters that are adjustable for each pixel;
a control unit that is configured to divide for each of a series of specific time periods the plurality of pixels into at least a first subset of pixels and a second subset of pixels, to set for each specific time period to the pixels of each subset a different parameter value of at least one of the imaging parameters, and to generate final images by using the image data obtained via the at least two subsets of pixels during the respective specific time period.

2. The sensor device according to claim 1, wherein
the control unit is configured to generate the final image also based on information about the division of the plurality of pixels into the different subsets of pixels.

3. The sensor device according to claim 1, wherein
the control unit is configured to set the different parameter values such as to cause complementary reconstruction properties for image data generation in the different subsets.

4. The sensor device according to claim 1, wherein
the control unit is configured to perform the division of the plurality of pixels into the subsets of pixels randomly.

5. The sensor device according to claim 1, wherein
the control unit is configured to perform the division of the plurality of pixels into the subsets of pixels at consecutive points in time based on an evaluation of previously generated final images.

6. The sensor device according to claim 5, wherein
the control unit is configured to change the pixel ratio of the number of pixels in the different subsets based on the evaluation of the previously generated final images.

7. The sensor device according to claim 6, wherein
the control unit is configured to segment the plurality of pixels into different areas based on the evaluation of the previously generated final images, and to divide the pixels in different areas according to different pixel ratios.

8. The sensor device according to claim 5, wherein
the control unit is configured to evaluate the previously generated final images by using a neuronal network.

9. The sensor device according to claim 1, wherein
the control unit is configured to generate during each specific time period predetermined intermediate images for each subset of pixels by using the image data generated by the pixels of the respective subset of pixels, and to generate the final images by fusing intermediate images of different subsets of pixels.

10. The sensor device according to claim 1, wherein
the control unit is configured to generate the final images by using an artificial intelligence model that receives the image data obtained via the at least two subsets of pixels during each specific time period and that outputs the final images.

11. The sensor device according to claim 1, wherein
the circuitry is configured to generate as image data event data that indicate intensity changes above an event detection threshold of the light; and
the at least one imaging parameter is one of the event detection threshold, a pixel bandwidth, and a refractory period during which a pixel is inert after event detection.

12. The sensor device according to claim 1, wherein
the circuitry is configured to generate as image data pixel signals indicating intensity values of the received light for each pixel; and
the at least one imaging parameter is one of pixel exposure time, pixel signal offset and pixel gain setting.

13. The sensor device according to claim 1, further comprising
a sensor chip on which the pixels and the circuitry are arranged; wherein
the sensor chip comprises a first port for outputting the image data from the sensor chip, and a second port for inputting control information for controlling the division of the plurality of pixels into the subsets of pixels and the parameter values of the at least one imaging parameter.

14. A method for operating a sensor device, the method comprising:
receiving light and performing photoelectric conversion with a plurality of pixels of the sensor device to generate an electrical signal;
generating with circuitry of the sensor device image data from the electrical signals based on imaging parameters that are adjustable for each pixel;
dividing for each of a series of specific time periods the plurality of pixels into at least a first subset of pixels and a second subset of pixels;
setting for each specific time period to the pixels of each subset a different parameter value of at least one of the imaging parameters; and
generating final images by using the image data obtained via the at least two subsets of pixels during the respective specific time period.
